(19) United States
(12) Patent Application Publication
(10) Pub. No.: US 2007/0253680 A1
(43) Pub. Date: Nov. 1, 2007

(54) Caption display control apparatus

(76) Inventors: Michiko Mizote, Osaka (JP); Yusuke Shiroyama, Osaka (JP); Masato Kihara, Kyoto (JP); Masaki Yoshioka, Osaka (JP)

Correspondence Address: MCDERMOTT WILL & EMERY LLP, 600 13TH STREET, NW, WASHINGTON, DC, 20005-3096, US

(21) Appl. No.: 11/785,805

(22) Filed: Apr. 20, 2007

(30) Foreign Application Priority Data
Apr. 26, 2006 (JP) 2006-121585
Apr. 11, 2007 (JP) 2007-103742

(51) Int. Cl. H04N 7/00; H04N 5/445

(52) U.S. Cl. 386/95; 348/564

(57) ABSTRACT

The entire caption is displayed within a display frame area through reducing the font size of the caption character string, scrolling the caption character string, or dividing the caption by a paragraph unit to be displayed separating more than once. When the entire character string cannot be displayed in a display frame area, the character string is divided by a word unit and through adding a continuation mark at the end of the caption, it is possible to inform the user that there is a continued part in the caption.

### BACKGROUND OF THE INVENTION

1. Field of the Invention

The present invention relates to a caption display control apparatus for a reproducing apparatus which displays a character string in a text information file of a recording medium where the text information file and video/audio data are managed in separate files as a caption within a prescribed display frame area.

2. Description of the Related Art

In the contents of a movie or the like having video and voice together, there is a caption as a way to visually express the lines and the like of the casts in the movie. FIG. 46 shows the schematic structure of an optical disk reproducing apparatus (DVD processor) DP that is capable of displaying captions. In FIG. 46, reference numeral 1 is a DVD drive, 2 is video/audio data, 3 is a text information file, 4 is a character string extraction processing section for extracting a character string for displaying as a caption from the text information file 3, and 6 is an onscreen display (OSD) which mixes the character string for displaying as the caption and a decoded result of the video/audio data 2.

As shown in FIG. 47, the video as the main contents is formed in a main video a1, and a sub-video a2 exists in the front thereof as a transmission video. A caption is displayed in such a manner that the main video a1 and the character a3 are superimposed by drawing a character a3 to the sub-video a2. By displaying like this, it is possible to execute switchover of with or without display of a caption, a caption selection and the like, without switching over the main video.

In a DVD-video in general, a single file contains both the image data for the main video a1 and a plurality of still-picture data for the sub-video a2, and a single sub-video can be selected from the plurality of sub-videos so as to be superimposed on the single main video.

As another example for realizing a caption display, Japanese Published Patent Literature (Japanese Unexamined Patent Publication 2004-363825) discloses a text caption that uses the text data of a file that is different from that of the image/audio data, and achieves a captioning function through using time/character data that is written in the text data. FIG. 48 shows an example of the text data used in the text caption. The text caption data is a text file consisting of a series of character strings where a plurality of a unit of caption data b, that is a pair of a caption display start/end timing (captioned time) and a character string for a caption display b2 paired thereto, is aligned.

In the text caption, as the file for the main video and the caption text file exist separately, the caption can be selected by changing the caption text file without retouching the data for the main video. Further, unlike the DVD-video, the caption text file in the text caption is not still-picture data. Therefore, at the time of reproduction, it is necessary to perform display by successively forming an image of the character data on the sub-video.

In the text caption, because the caption data is a different text file from the file of the image/audio data, a capacity for the caption data is further reduced compared to the caption of the DVD-video by the still-picture. In addition, there is such advantage that the caption data can be changed or edited easily.

In the text caption, however, the size and position of the display frame area where the caption is displayed and the font size of the caption character are being fixed. Thus, when the data having an extremely large number of characters contained in a unit caption data is displayed, there is such a problem that it is not possible to display all the characters within the display frame area.

Furthermore, the text information file contains only the character information and the caption display start/end timing as the information. Thus, the display position and the color of the caption cannot be displayed in an optimum manner in all the video scenes. For example, there is a problem that the user (viewer) cannot understand who is the speaker when a plurality of casts is displayed on the screen.

### SUMMARY OF THE INVENTION

The main object of the present invention therefore is to make the caption display more effective.

In order to achieve the aforementioned object,

(1) A caption display control apparatus according to the present invention is a caption display apparatus which reads out data from a recording medium in which main data including video data and text data are recorded respectively in separate files, and displays a character string generated from said text data in a prescribed display frame area within a video generated from said main data as a caption, and said apparatus comprising:
a judging device for defining a reference character number indicating a number of characters that can be stored within said display frame area with an initialized character font size, and then judging whether or not a character number of said character string exceeds said reference character number; and
a display control device for displaying said character string with said character font size in said display frame area when said character number of said character string does not exceed said reference character number, and displaying said character string in a visually recognizable state in said display frame area or displays said character string in said display frame area by converting so that it can be visually recognized that said character number of said character string exceeds said reference character number, when said character number of said character string exceeds said reference character number.

(2) When said character number of said character string exceeds said reference character number, it is preferable that said display control device reduces said character font size of said character string. Since the font size of said character string is reduced when said character number of said unit caption in said text file information is larger than said reference character number that can be displayed within said display frame area all at once when a predetermined regular font size is used in said reproducing apparatus, said entire caption can be displayed within said display frame area.

(3) When said character number of said character string exceeds said reference character number, it is preferable that said display control device scroll-displays said character string in said display frame area. In this case, said character string is scroll-displayed when said character number of said unit caption exceeds said reference character number. Therefore, said entire caption can be displayed within said display frame area.

(4) When said character number of said character string exceeds said reference character number, it is preferable that said display control device divides said character string by a paragraph unit, and displays each of partial character strings obtained by dividing said character string sequentially in chronological order. In this case, when said character number of said unit caption (character string) exceeds said reference character number, each of said partial character string is displayed sequentially within one-time caption display period. Thus, said entire caption can be displayed within said display frame area without lack of a character string.

(5) When said character number of said character string exceeds said reference character number, it is preferable that said display control device divides said character string by a word unit into a displayable partial character string that can be displayed in said display frame area and a non-displayable partial character string, and then display said displayable partial character string in said display frame area. In this case, when said character number of said unit caption (character string) exceeds said reference character number, only said displayable partial character string is displayed. Thus, said entire caption can be displayed without ending in a halfway display of said character string within said display frame area.

(6) When said character number of said character string exceeds said reference character number, it is preferable that said display control device divides said character string into a displayable partial character string that can be displayed in said display frame area and a non-displayable partial character string, and display said displayable partial character string in said display frame area by adding a continuation mark to said displayable partial character string, indicating that there is a partial character string that cannot be displayed. In this case, when said character number of said unit caption exceeds said reference character number, the continuation mark (for example, “ - - - ” or [symbol] ) is added to said displayable partial character string, and said caption is displayed in such a manner that said character string with said continuation mark is fitted within said display frame area.

(7) The present invention is a caption display control apparatus for reading out data from a recording medium in which main data including video data and text data are recorded in separate files respectively, and displaying, as a caption, a character string generated from said text data in a prescribed display frame area within a video generated from said main data, said apparatus comprising:
a calculater for calculating a display speed that is a display time per character by dividing said character number of said character string by a length of display time in said display frame area; and
a display control device for a partial character string of said character string to be displayed in said display frame area with a color different from that of other partial character strings, and shifts said partial character string in different color from a front of said character string to an end thereof at a moving speed that is same as the display speed. In this case, the color of the caption is changed in accordance with the state of progress in the video scenes. Therefore, it is possible to grasp the current state by simply looking at the caption, and the caption can be displayed in the optimum way in all the video scenes.

(8) Still another aspect of the present invention is
a measuring device for successively measuring an audio frequency of said audio data; and
a display control device for successively changing a display color of said character string to be displayed in said display frame area in accordance with said audio frequency measured by said measuring device. In this case, in expressing said conversation between a man and a woman, said character string thereof maybe expressed, for example, with blue because a male voice has a low sound frequency, whereas said character string thereof may be expressed, for example, with red because a female voice has a high sound frequency. Herewith, it becomes easier for the user to know which person (man or woman) is speaking by simply looking at the caption.

(9) Yet another aspect of the present invention is a caption display control apparatus for reading out data from a recording medium in which main data including video data and audio data and text data are recorded in separate files respectively, and displaying, as a caption, a character string generated from said text data in a prescribed display frame area within a video generated from said main data, said apparatus comprising:
an amplitude checking device for checking an amplitude distribution of said audio data in said display frame area; and
a display control device for unevenly distributing said character string in a part of said display frame area with a larger amplitude. In this case, it is possible to judge which position the sound comes from by simply looking at the caption because said character string is distributed in the region of said display frame area with the larger amplitude disproportionately. Therefore, the current state can be grasped by the display position of the caption.

(10) Another aspect of the present invention is a caption display control apparatus for reading out data from a recording medium in which main data including video data and audio data and text data are recorded in separate files respectively, and displaying, as a caption, a character string generated from said text data in a prescribed display frame area within a video generated from said main data, said apparatus comprising:
a comparator for comparing an aspect ratio of said video data and an aspect ratio of a video display monitor for displaying said video data; and
a display control device for moving said display frame area in a display screen of said video display monitor in accordance with a result of comparing said both aspect ratios.

(11) In the above-described structure, when there is a difference between said both aspect ratios, it is preferable that said display control device moves said display frame area to a non-image part that is generated in said display screen of said video display monitor due to said difference between said aspect ratios. In this case, when reproducing a material video whose aspect ratio is different from the aspect ratio of the video display monitor, a non-image part is generated in the top and the bottom sides of the screen when the material video is longer in the lateral direction to the monitor, whereas a non-image part is generated on the right and left sides of the screen when the material video is longer in the longitudinal direction to the monitor. Since said display frame area is moved to the non-image part to display the caption, the video is not disturbed by the caption.

(12) The above-described structure further comprising a luminance checking device for checking luminance distribution of said video data, wherein

when said both aspect ratios are equal, said display control device moves said display frame area to a part of said display screen of said video display monitor with less luminance change. In this case, since the caption is displayed by moving said display frame area to the area with less luminance change in the material video, it is possible to avoid displaying the caption at a position that the user is keen on.

(13) Furthermore, in the above-described structure, when the both aspect ratios are equal, it is preferable that said display control device reduces displayed video and moves said display frame area to a non-image part that is generated by reducing said displayed video. Since said aspect ratios are equal in this case, the material video is reduced to form said non-image part so as to display the caption in the non-image part. Thus, the caption does not disturb the video.

According to the present invention described above, it is possible to display the entire caption within the display frame area through reducing the font size of the caption character string, scrolling the caption character string, dividing the caption by a unit of paragraph so as to display the divided character strings in a plurality of times, etc.

Further, when the entire character string cannot be displayed within the display frame area, it is possible to inform the user that there is a continued part in the caption, through dividing the display with a word unit and adding a continuation mark at the end of the caption.

The position of the display frame area or the color of the character string is changed in each of the video scenes through using various kinds of information contained in the video/audio data, so that the optimum caption display for the scenes can be achieved.

The caption display control method for a reproducing apparatus according to the present invention can be utilized not only for the case of the video/audio data on the optical disks but also for the case of the next-generation blue-ray disks and HD DVDs.

### BRIEF DESCRIPTION OF THE DRAWINGS

Other objects of the present invention will become clear from the following description of the preferred embodiments and the appended claims. Those skilled in the art will appreciate that there are many other advantages of the present invention by embodying the present invention.

FIG. 1 is a block diagram showing the state of the processing in a caption display control method according to a first embodiment of the present invention;

FIG. 2 is a first flowchart showing the processing order in the caption display control method according to the embodiment of the present invention;

FIG. 3 is an indicator chart of a caption, in the case where the number of characters exceeds the displayable range;

FIG. 4 is a diagram of displaying a caption according to the embodiment of the present invention, in which the character font size of the whole character string is reduced;

FIG. 5 is a second flowchart showing the processing order of the caption display control method according to an embodiment of the present invention;

FIG. 6 is an illustration of displaying the caption by scrolling the character string according to the embodiment of the present invention;

FIG. 7 is a third flowchart showing the processing order of the caption display control method according to an embodiment of the present invention;

FIG. 8 is an illustration of displaying the caption by dividing the character string according to the embodiment of the present invention;

FIG. 9 is a fourth flowchart showing the processing order of the caption display control method according to an embodiment of the present invention;

FIG. 10 is an illustration of displaying the caption by dividing the character string by a word unit according to the embodiment of the present invention;

FIG. 11 is a fifth flowchart showing the processing order of the caption display control method according to an embodiment of the present invention;

FIG. 12 is an illustration of displaying the caption with a sign indicating that there is a continued caption in a non-displayable part according to the embodiment of the present invention;

FIG. 13 is a first flowchart showing the processing order of the caption display control method for obtaining the video effect according to an embodiment of the present invention;

FIG. 14 is an illustration of displaying the caption while changing the caption color in accordance with the reproducing time according to the embodiment of the present invention;

FIG. 15 is a second flowchart showing the processing order of the caption display control method for obtaining the video effect according to an embodiment of the present invention;

FIG. 16 is an illustration of displaying the caption while changing the caption color in accordance with the frequency of the sound according to the embodiment of the present invention;

FIG. 17 is a third flowchart showing the processing order of the caption display control method for obtaining the video effect according to an embodiment of the present invention;

FIG. 18 is an illustration of displaying the caption while changing the position for displaying the caption in accordance with the magnitude of the sound amplitude according to an embodiment of the present invention;

FIG. 19 is a first flowchart showing the order of processing for determining caption display position according to an embodiment of the present invention;

FIG. 20 is an illustration of displaying the caption at a position where the main video is not displayed according to the embodiment of the present invention;

FIG. 21 is a second flowchart showing the order of caption display position determining processing according to an embodiment of the present invention;

FIG. 22 is an illustration of displaying the caption at a position of the main video where there is less change in the luminance according to an embodiment of the present invention;

FIG. 23 is a third flowchart showing the order of processing foe determining caption display position according to an embodiment of the present invention;

FIG. 24 is an illustration of reducing the main video in size to display the caption at a position where the main video is not displayed according to an embodiment of the present invention;

FIG. 25 is a sixth flowchart for showing the processing order of the caption display control method according to an embodiment of the present invention;

FIG. 26 is a seventh flowchart showing the processing order of the caption display control method according to an embodiment of the present invention;

FIG. 27 is an eighth flowchart showing the processing order of the caption display control method according to an embodiment of the present invention;

FIG. 28 is a ninth flowchart showing the processing order of the caption display control method according to an embodiment of the present invention;

FIG. 29 is a tenth flowchart showing the processing order of the caption display control method according to an embodiment of the present invention;

FIG. 30 is an eleventh flowchart showing the processing order of the caption display control method according to an embodiment of the present invention;

FIG. 31 is a twelfth flowchart showing the processing order of the caption display control method according to an embodiment of the present invention;

FIG. 32 is a thirteenth flowchart showing the processing order of the caption display control method according to an embodiment of the present invention;

FIG. 33 is a fourteenth flowchart showing the processing order of the caption display control method according to an embodiment of the present invention;

FIG. 34 is a fifteenth flowchart showing the processing order of the caption display control method according to an embodiment of the present invention;

FIG. 35 is a sixteenth flowchart showing the processing order of the caption display control method according to an embodiment of the present invention;

FIG. 36 is a seventeenth flowchart showing the processing order of the caption display control method according to an embodiment of the present invention;

FIG. 37 is an eighteenth flowchart showing the processing order of the caption display control method according to an embodiment of the present invention;

FIG. 38 is a nineteenth flowchart showing the processing order of the caption display control method according to an embodiment of the present invention;

FIG. 39 is a twentieth flowchart showing the processing order of the caption display control method according to an embodiment of the present invention;

FIG. 40 is a twenty-first flowchart showing the processing order of the caption display control method according to an embodiment of the present invention;

FIG. 41 is a twenty-second flowchart showing the processing order of the caption display control method according to an embodiment of the present invention;

FIG. 42 is a fourth flowchart showing the processing order of the caption display control method for obtaining the video effect according to an embodiment of the present invention;

FIG. 43 is a fifth flowchart showing the processing order of the caption display control method for obtaining the video effect according to an embodiment of the present invention;

FIG. 44 is a sixth flowchart showing the processing order of the caption display control method for obtaining the video effect according to an embodiment of the present invention;

FIG. 45 is a seventh flowchart showing the processing order of the caption display control method for obtaining the video effect according to an embodiment of the present invention;

FIG. 46 is a schematic diagram of an optical disk reproducing apparatus according to a conventional technique capable of displaying a caption;

FIG. 47 is a block diagram for showing a structure of a caption-displayed screen according to the conventional technique; and

FIG. 48 is an illustration showing the contents of a text information file.

### DETAILED DESCRIPTION OF THE INVENTION

Hereinafter, as an embodiment of the present invention, description is given to a caption display control method in reproducing an optical disk in which a text information file and the video/audio data are managed in separate files, referring to the representative drawing. In addition, the media for managing the data files are not limited only to the optical disks, but maybe HDDs or semiconductor recording media. Furthermore, the same reference numerals are applied to the common processing, judgments and the like in embodiments described below, since the details thereof will be described only in the first appearance, and the same reference numerals are simply applied in describing again and the description thereof will be omitted.

### First Embodiment

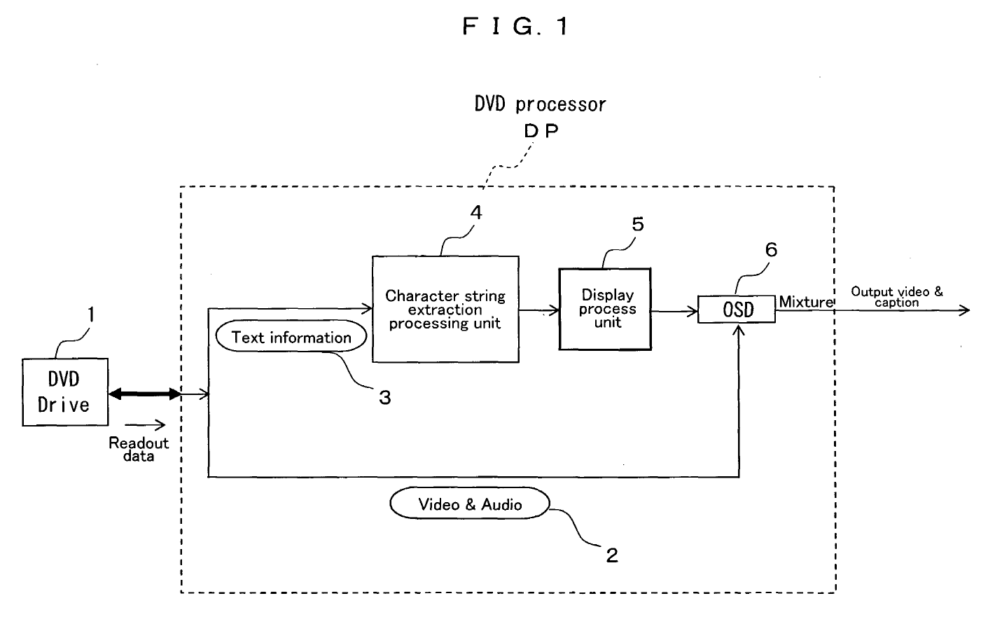

FIG. 1 is a block diagram r showing the mode of the processing of the caption display control method in a reproducing apparatus (caption display control apparatus) according to a first embodiment of the present invention. First, the specific data flow according to the present invention will be described. As shown in FIG. 1, a DVD processor DP reads out video/audio data 2 (Hello. asf) and a text information file 3 that contains caption data (Hello. srt) in a DVD drive 1. The video/audio data 2 and the text information file 3 are within a same directory, and have the same file names except for the extensions. A character string b2 part for displaying the caption in FIG. 48 is extracted from the text information file 3 by a character string extraction processing unit 4, the extracted character string b2 is processed for display by a display process unit 5, and it is mixed with an encoded result of the video/audio data 2 in an onscreen display 6 so as to output an image and a caption. However, it is noted that copyright-free files (possible to be changed in regards to the caption display control method) should be considered as the text information file 3. As shown in FIG. 48, an SRT format which contains caption display start/end timing b1 and a character string b2 to be displayed as the caption is used as an example of the text information file 3.

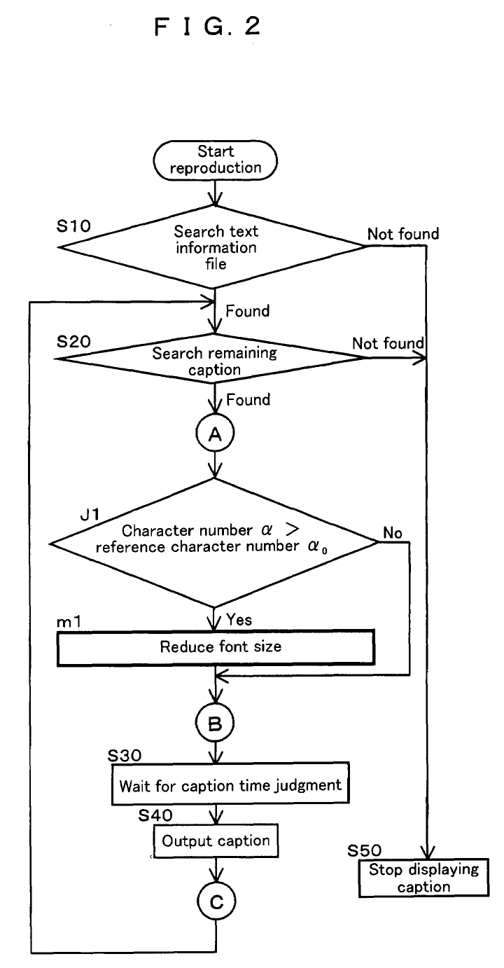

FIG. 2 is a flowchart showing the order of the processing of the caption display control method in the reproducing apparatus according to the embodiment of the present invention. In step S10, the DVD drive 1 performs a search for the text information file 3. When there is no text information file 3 therein, the processing is shifted to step S50 to end the caption processing.

Next, when there is the text information file 3, the processing is advanced to step S20 to perform a search for remaining caption. If there is no remaining caption, the caption processing is ended. If there is found a remaining caption, a first character number judgment is carried out. That is, it is judged whether or not character number α of a unit caption, that is the number of characters of a character string b2 to be displayed as the caption, is more than a reference character number α₀, that is a number of characters normally displayable in a prescribed display frame area, every unit caption data b (see FIG. 48 with respect to the unit caption data b and the character string b2).

When a regulated standard font is used in a reproducing apparatus, with NTSC 720×480 as a reference, it is assumed here that 720×240 is a character display frame area by considering a half the screen as the maximum area, for example. When it is defined to display three-row characters in the character display frame area, it is possible to display 80×80, namely, nine characters in the lateral direction provided that it is eighty pixels in the longitudinal direction, and the longitudinal and lateral sizes of one character are the same. In the case where PAL 720×576 is used as a reference, the character display frame area becomes 720×288, and the longitudinal and lateral sizes of one character becomes 96×96. Thus, seven characters can be displayed in the lateral direction.

When it is judged in a first judgment j1 that the character number α is larger than the reference character number α₀ in, the processing is advanced to font-size reducing processing m1. If not, the processing ml is skipped and the processing proceeds to step S30.

In the font-size reducing processing m1, the font size is reduced by each character string (base caption unit) b2 to be displayed as the caption at once during the period of the caption display start/end timing b1 as shown in FIG. 4, so that the entire character string can fall within the display frame area. For changing the font size, any kinds of methods can be selected from a method of reducing it in the longitudinal direction, a method of reducing it in the lateral direction and a method of reducing it in both the longitudinal and lateral directions.

The processing of the first character number judgment J1 and the font-size reducing processing m1 can be executed by the character string extraction processing unit 4 and the display process unit 5 in cooperation.

Waiting for the caption time judgment in step S30, the processing proceeds to step S40 to output the caption when the caption is typed up, and then returned to step S20 to perform remaining caption search. The processing from step S20→the first character number judgment J1→the font-size reducing processing m1→step S30 step S40 is repeatedly executed, until there is no more remaining caption.

The outline of the embodiment consists of a series of the processing, “the first character number judgment J1—the font-size reducing processing m1”. This can be simply expressed as “J1-m1”.

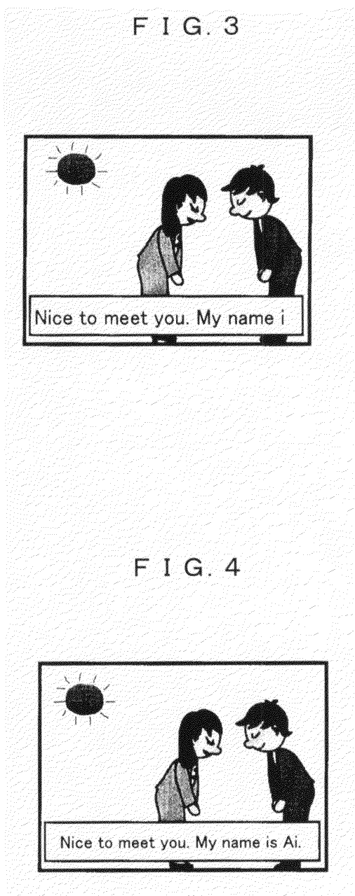

Hereinafter, a specific example will be described. It is assumed here that, when a regulated standard font is used in a reproducing apparatus at a video scene as in FIG. 3 where a man and a woman exchange a greeting, the character string b2 to be displayed as the caption in the text information file 3, i.e. “Nice to meet you. My name is Ai”, exceeds the display frame area.

In a conventional caption display control method, it is not possible to display all the characters, and the character string is cut in the middle on the display. In the caption display control method according to the embodiment, however, the font size to fall within the display frame area can be obtained from the characters and the number of characters in the character string b2 to be displayed as the caption, i.e. “Nice to meet you. My name is Ai”, so that the entire character string b2 to be displayed as the caption can fall within the display frame area. Then, the font size is reduced from the standard font size to the obtained font size in both the longitudinal and lateral directions to display the caption. Herewith, as shown in FIG. 4, the entire character string can be displayed within the display frame area, and a user can see the whole caption.

Next, second to thirty-second embodiments will be described hereinafter. The flowcharts of those embodiments are basically the same as the flowchart of FIG. 2 described in the first embodiment only with some modifications. That is, the processing performed between the nodal points A and B is modified in each embodiment. It is the same for the processing performed from the points A to C. However, the contents of the first character number judgment J1 are the same for all the embodiments.

### Second Embodiment

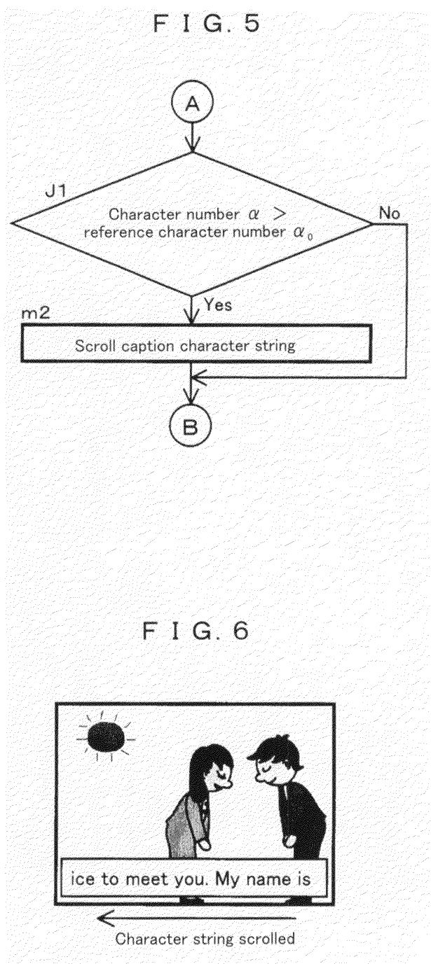

FIG. 5 is a flowchart showing the order of the processing of the caption display control method for the reproducing apparatus (caption display control apparatus) according to a second embodiment of the present invention. When it is judged in step S20 that there is a remaining caption, the first character number judgment J1 is carried out. When it is judged in the first judgment J1 that the character number α of the unit caption (character string) is larger than the reference character number α₀, character string scroll processing m2 is performed. That is, in order to display the entire character string within the display frame area, the caption character string is scrolled in the lateral direction (from the right to left, from the left to right) and in the longitudinal direction (from the bottom to top, from the top to bottom) from the currently viewed position, as shown in FIG. 6. When the character number α of the unit caption is equal or smaller than the reference character number α₀, the processing m2 is not carried out. After performing the above-described processing J1 and m2, it is shifted to step S30 of FIG. 2.

The outline of the embodiment consists of a series of the processing, “the first character number judgment J1—the character string scroll processing m2”. This can be simply expressed as “J1-m2”.

In the case of the lateral-direction scroll, the currently displayed characters are deleted in the displayed order, and the continued characters are displayed on the deleted position. Further, in the case of the longitudinal-direction scroll, the currently displayed entire character string is deleted, and the continued character string is displayed on the deleted position. Particularly, the longitudinal-direction scroll is effective when there is a plurality of caption character rows on the onscreen display.

### Third Embodiment

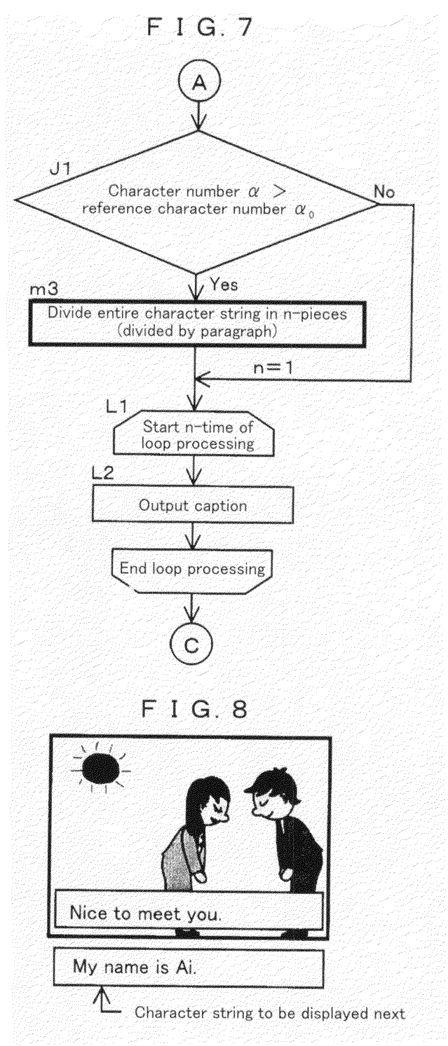

FIG. 7 is a flowchart showing the order of the processing of the caption display control method in the reproducing apparatus (caption display control apparatus) according to a third embodiment of the present invention.

When it is judged in step S20 that there is a remaining caption, the first character number judgment J1 is carried out. When it is judged in the first judgment J1 that the character number α of the unit caption (character string) is larger than the reference character number α₀, character string paragraph division processing m3 is performed. That is, in order to display the entire character string within the display frame area without a missing part, the entire character string is divided into partial character strings by each paragraph as shown in FIG. 8. For this, a word/phrase dividing function, is used in order to identify division point of the words/phrases based on a space, comma, auxiliary word or the like, and divide the character string at the identified division points. The divided number is assumed to be “n”. When the character number α of the unit caption is judged smaller than or equal to the reference character number α₀, the processing m3 is not carried out.

Then, n-times of loop processing are started in step L1, and output of the caption is carried out in step L2. When display of the partial character strings is completed over n-times, the processing is returned to step S20 where the remaining caption search is performed. As a result, divided display of the entire character string can be completed within the period of the caption display start/end timing b1. After performing the above-mentioned processing J1 and m3, it is returned to step S20 of FIG. 2.

The outline of the embodiment consists of a series of the processing, “the first character number judgment J1—the character string paragraph division processing m3”. This can be simply expressed as “J1-m3”.

### Fourth Embodiment

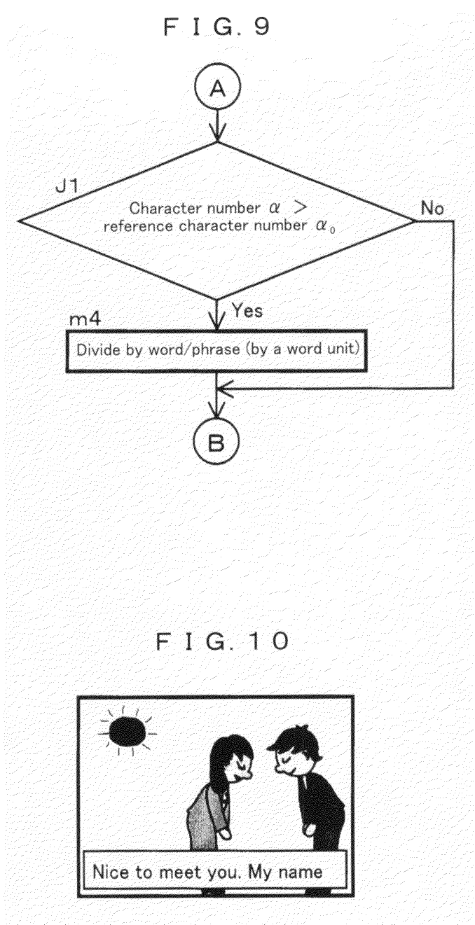

FIG. 9 is a flowchart showing the order of the processing of the caption display control method in the reproducing apparatus according to a fourth embodiment of the present invention. When it is judged in step S20 that there is a remaining caption, the first character number judgment J1 is carried out. When it is judged in the first judgment J1 that the character number α of the unit caption (character string) is larger than the reference character number α₀, character string word unit dividing processing m4 is performed. That is, the character string is divided into partial character strings by a word unit through a word/phrase dividing function, and the partial character strings are displayed so as to be displayed by a word unit within the display frame area as shown in FIG. 10, so that the character string is not ended in a halfway within the display frame area. When the character number α of the unit caption is equal to or smaller than the reference character number α₀, the processing m4 is not carried out. After performing the above-described processing J1 and m4, it proceeds to step S30 of FIG. 2.

The outline of the embodiment consists of a series of the processing, “the first character number judgment J1—the character string word unit dividing processing m4”. This can be simply expressed as “J1-m4”.

### Fifth Embodiment

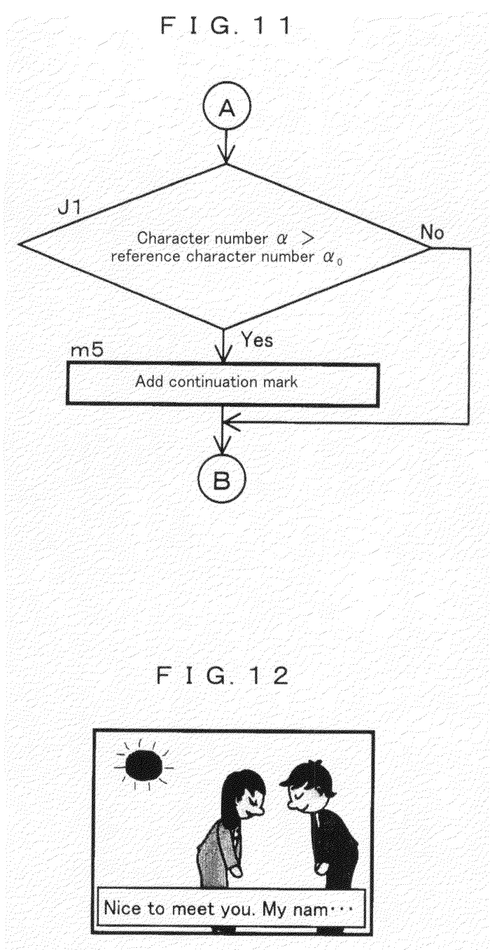

FIG. 11 is a flowchart showing the order of the processing of the caption display control method in the reproducing apparatus (caption display control apparatus) according to a fifth embodiment of the present invention. When it is judged in step S20 that there is a remaining caption, the first character number judgment J1 is carried out. When it is judged in the first judgment J1 that the character number α of the unit caption (character string) is larger than the reference character number α₀, continuation mark adding processing m5 is performed. That is, in order to inform the user that there is a part of the character string that is not being displayed and there is a continued part in the caption, a continuation mark (e.g. “ - - - ” existing at the end of the caption in shown FIG. 12) which indicates that there is a continued part in the caption is added to the displayable partial character string in order to display it. For the continuation mart to be added, any marks such as [symbol] etc. may be used, as long as it indicates that there is a continued part. Then, the caption is displayed in such a manner that the partial character string with the mark indicating that there is a continued part falls within the display frame area. When the character number α of the unit caption is equal to or smaller than the reference character number α₀, the processing m5 is not carried out. After performing the above-described processing J1 and m5, it is shifted to step S30 of FIG. 2.

The outline of the embodiment consists of a series of the processing, “the first character number judgment J1—the continuation mark adding processing m5”. This can be simply expressed as “J1-m5”.

### Sixth Embodiment

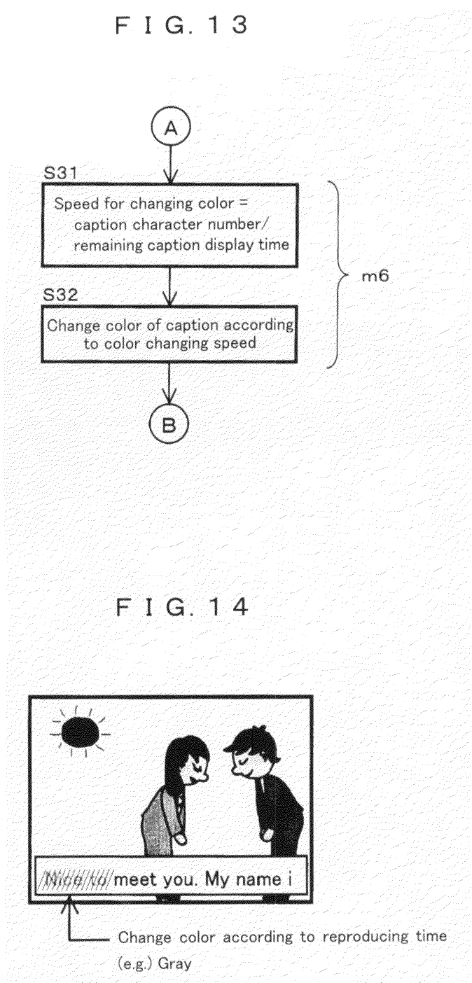

FIG. 13 is a flowchart showing the order of the processing of the caption display control method in the reproducing apparatus (caption display control apparatus) according to a sixth embodiment of the present invention. When it is judged in step S20 that there is a remaining caption, caption color scroll processing m6 is performed in this embodiment. That is, first, the number of remaining caption characters is divided by the caption display period in step S31 to obtain the speed for changing the color (color changing speed) in accordance with information on the reproducing time of the video/audio data 2, in order to display the caption in the optimum way in all the scenes by using colors.

Then, in step S32, the color of the caption is changed from the displayed forehand character at the derived color changing speed. As shown in FIG. 14, by coloring the reproduced caption displayed part in gray or the like, it is possible for the user to grasp the current state by simply looking at the caption. After performing the processing m6, it is shifted to step S30 of FIG. 2.

### Seventh Embodiment

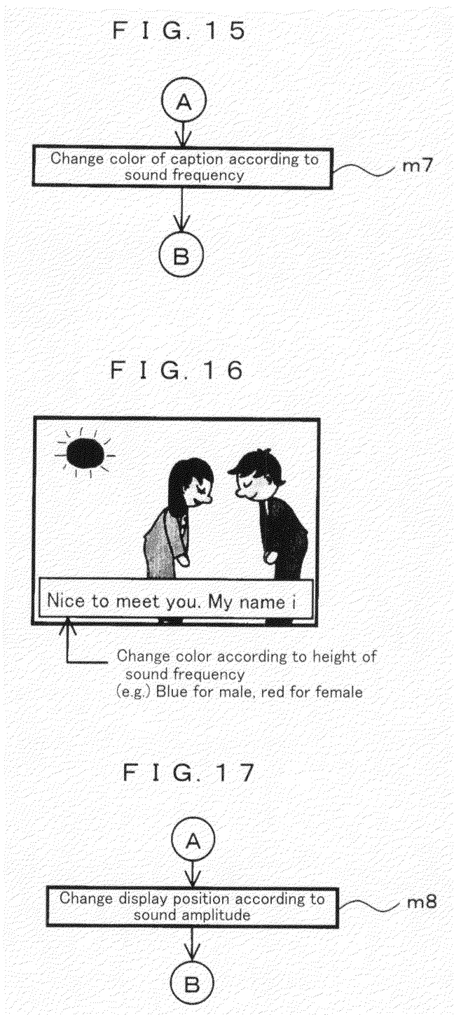

FIG. 15 is a flowchart showing the order of the processing of the caption display control method in the reproducing apparatus (caption display control apparatus) according to a seventh embodiment of the present invention. When it is judged in step S20 that there is a remaining caption, caption color changing processing m7 is performed in this embodiment. That is, in order to display the caption in the optimum way in all the scenes by using colors, the color of the caption is changed in accordance with the frequency of the sound based on the sound information of the video/audio data 2. As shown in FIG. 16, in expressing the conversation between a man and a woman, the character string may be expressed with blue since a male voice has a low sound frequency, whereas the character string may be expressed with red because a female voice has a high sound frequency. As a result, it becomes easier for the user to know which person is speaking. After performing the processing m7, it is shifted to step S30 of FIG. 2.

According to this embodiment, the speaker is specified during the display of the caption through utilizing the result of analyzing the audio frequency in displaying the caption. In a video scene where a man and a woman exchange a greeting, when there are more high-tone components as a result of the audio frequency analysis, it can be specified as a speech of the woman. Thus, the caption is changed to red, so that the user can grasp the current state by looking at the video scene and the caption.

### Eighth Embodiment

FIG. 17 is a flowchart showing the order of the processing of the caption display control method in the reproducing apparatus (caption display control apparatus) according to an eighth embodiment of the present invention. When it is judged in step S20 that there is a remaining caption, caption display position changing processing m8 is performed in this embodiment. That is, in order to make the display position optimum for all the video scenes, the caption is displayed by moving the display frame area to the position with a larger amplitude side in accordance with the magnitude of the sound amplitudes on the right and left side, based on the sound information of the video/audio data 2. After performing the processing m8, it is shifted to step S30 of FIG. 2.

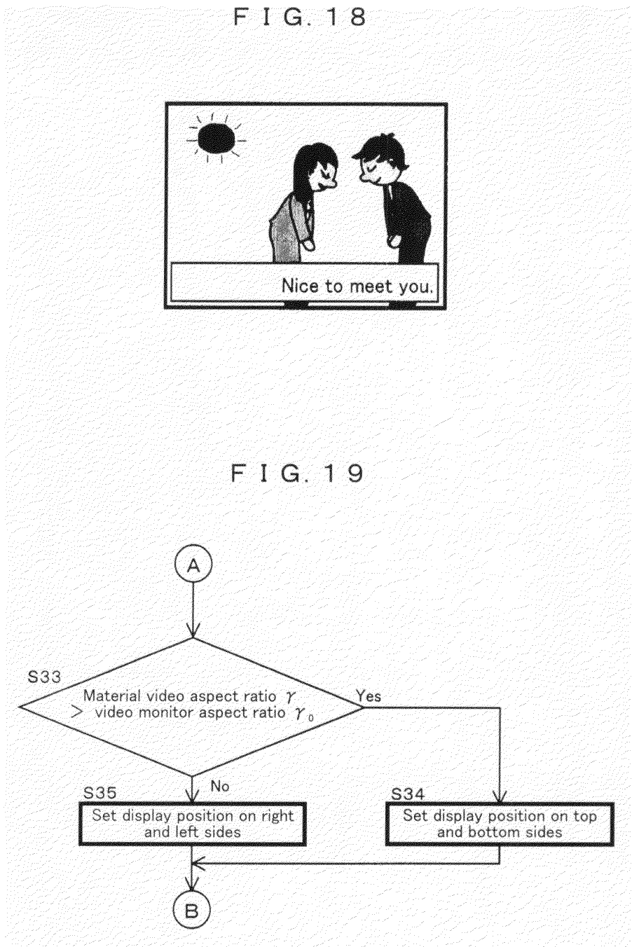

As shown in FIG. 18, through displaying the captions by moving the display frame area, it is possible for the user to know which position (on the right or the left) the sound comes from by simply looking at the captions. In addition, in a conversation, it is possible to judge which position of the person's voice is larger so as to grasp the current state by the display position of the caption.

### Ninth Embodiment

FIG. 19 is a flowchart showing the order of the processing of the caption display control method in the reproducing apparatus (caption display control apparatus) according to a ninth embodiment of the present invention. This embodiment relates to a caption display control method in the case where the aspect ratio γ of a material video is different from the aspect ratio γ₀ of the video display monitor.

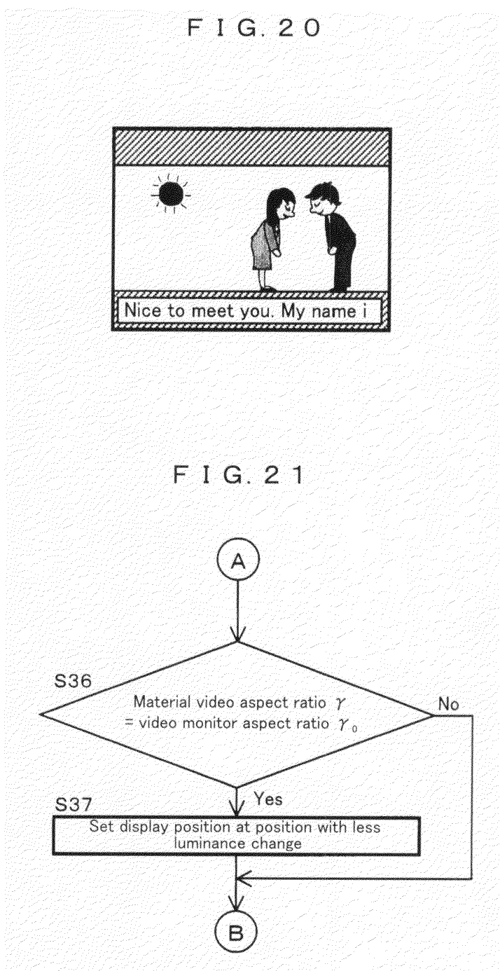

There are 16:9, 4:3, etc as example of the aspect ratio. These can be expressed in numerical values as 16/9=1.78, 4/3≈1.33, etc. For example, in FIG. 20, the material video aspect ratio γ=16/9≈1.78 and the video display monitor aspect ratio γ₀=4/3≈1.33, which means that the material video aspect ratio γ is larger than the video display monitor aspect ratio γ₀(γ>γ₀). The aspect ratio indicates the degree of the length in the lateral direction.

When it is judged in step S20 that there is a remaining caption, step S33 is carried out. In step S33, it is judged whether or not the material video aspect ratio γ is larger than the video display monitor aspect ratio γ₀. That is, it is judged whether or not the material video has a strong tendency to be longer in the lateral direction in relation to the display monitor. When it is judged as γ>γ₀, it is shifted to step S34 to display the character string of the text information file in letter box no-image parts generated on the top and bottom sides. Inversely, when it is judged as γ≦γ₀, it is shifted to step S35 to display the character string of the text information file in the no-image parts of the longitudinal direction generated on the right and left sides.

It is effective to write the caption laterally in displaying the character string in the laterally long no-image parts generated on the top and bottom sides. Further, it is effective to write the caption vertically in displaying the character string in the vertically long no-image parts generated on the right and left sides. However, it is not limited to this embodiment, and the character string may be displayed in vertical writing or lateral writing. According to this embodiment, the caption does not interfere with the main video. After performing the above-described steps S33-S35, it is shifted to step S30 of FIG. 2.

### Tenth Embodiment

FIG. 21 is a flowchart showing the order of the processing of the caption display control method in the reproducing apparatus (caption display control apparatus) according to a tenth embodiment of the present invention.

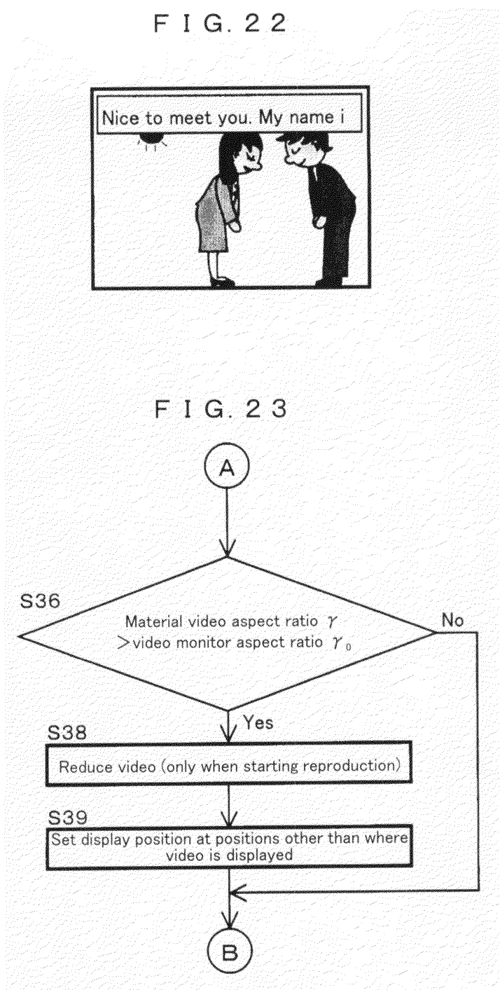

When it is judged in step S20 that there is a remaining caption, step S36 is carried out. In step S36, it is judged whether or not the material video aspect ratio γ is equal to the video display monitor aspect ratio γ₀. When it is equal, it is shifted to step S37 to display the character string of the text information file 3 at a position where there is less change in the luminance in the space direction of the material video, as shown in FIG. 22. When it is not equal, step S37 is skipped and the character string is displayed at a previously regulated position. After performing the above-described steps S36 and S37, it proceeds to step S30 of FIG. 2.

The following processing is performed in order to determine the position where there is less change in the luminance. That is, the screen is sectioned into some areas. For example, it is divided into eight areas in the lateral direction if the characters are aligned in the lateral direction. Then, the luminance of each area is added up every one second and the average value is calculated in every ten seconds. The area with the smallest change is determined as the position with less luminance change in the space direction of the material video. Then, the caption is displayed for the next ten seconds. According to this embodiment, the caption is displayed at the position where there is less change in the video, so that the position without displaying the caption at the position where the user may be highly attracted.

### Eleventh Embodiment

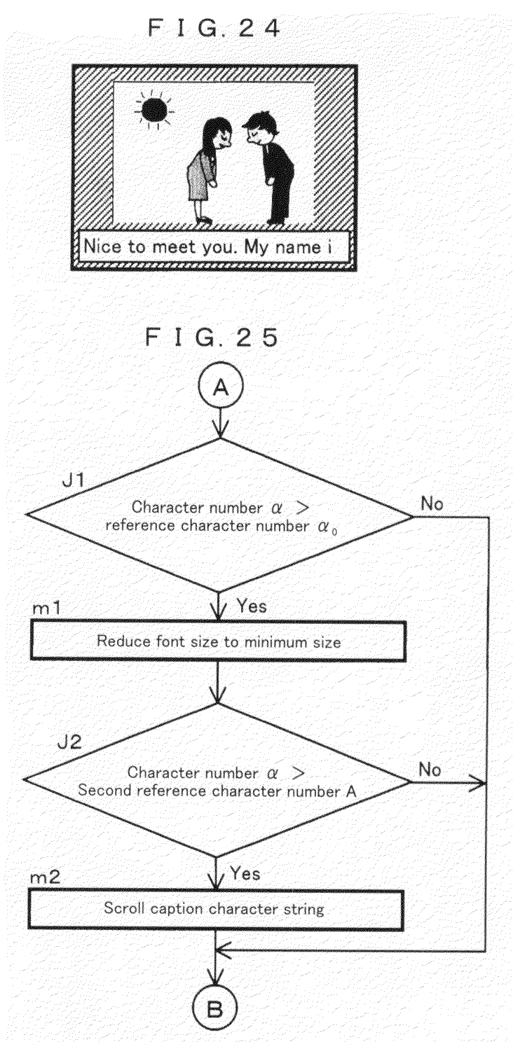

FIG. 23 is a flowchart showing the order of the processing of the caption display control method in the reproducing apparatus (caption display control apparatus) according to an eleventh embodiment of the present invention. When it is judged in step S20 that there is a remaining caption, step S36 is carried out. In step S36, it is judged whether or not the material video aspect ratio γ is equal to the video display monitor aspect ratio γ₀. When it is equal, it is shifted to step S38 to reduce the size of the material video as a whole as shown in FIG. 24. Then, in step S39, the no-image part where the video is not displayed is generated on the top and bottom sides and the right and left sides of the material video to display the caption therein. After performing the above-described processing, it is shifted to step S30 of FIG. 2. When it is judged in step S36 that the material video aspect ratio γ is not equal to the video display monitor aspect ratio γ₀, the processing is shifted to step S30 of FIG. 2, without performing steps S38 and S39.

According to this embodiment, the captions do not interfere with the main video. When the character number α is equal to or smaller than the reference character number α₀, steps S38 and S39 are not carried out. After performing the above-described steps S36, S38 and S39, it is shifted to step S30 of FIG. 2.

### Twelfth Embodiment

FIG. 25 is a flowchart showing the order of the processing of the caption display control method in the reproducing apparatus (caption display control apparatus) according to a twelfth embodiment of the present invention. It is assumed here that the user determines the allowable minimum size in advance in case of reducing the font size.

When it is judged in step S20 that there is a remaining caption, the first character number judgment J1 is carried out. When it is judged in the first judgment J1 that the character number α of the unit caption (character string) is larger than the reference character number α₀, font size reduction processing m1 is performed in order to display the entire character string within the display frame area by reducing the font size at a basic caption (character string) unit so that the entire character string falls within the display frame area. At that time, the font size is reduced to the above-described minimum size. When the character number α of the unit caption is equal to or smaller than the reference character number α₀, the processing is shifted to step S30 of FIG. 2 without performing the processing m1.

If the entire character string cannot be displayed even after performing the processing m1, second character number judgment J2 is carried out to judge whether or not the character number α of the unit caption (character string) is larger than a second reference character number A. The second reference character number A is the number of characters that can be displayed in the display frame area with the above-described minimum font size. When the character number α of the unit caption is smaller than the reference character number A, the processing is shifted to step S30 of FIG. 2 without performing the character string scroll processing m2. When the character number α of the unit caption is larger than the reference character number A, the character string scroll processing m2 is performed to scroll the caption character string. After performing the processing m2, it is shifted to step S30 of FIG. 2.

The outline of the embodiment consists of a series of the processing, “the first character number judgment J1—the font size reduction processing m1—the second character number judgment J2—the character string scroll processing m2”. This can be simply expressed as “J1-m1-J2-m2”.

### Thirteenth Embodiment

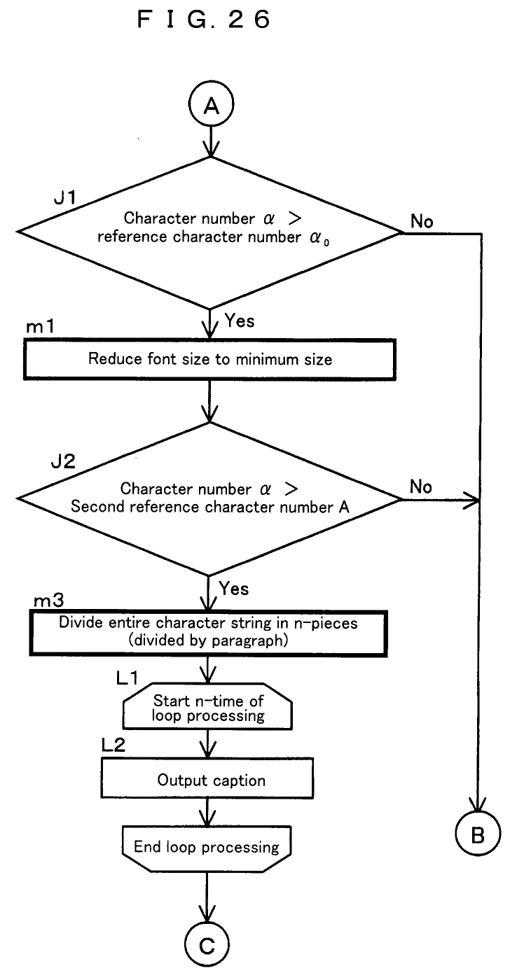

FIG. 26 is a flowchart showing the order of the processing of the caption display control method in the reproducing apparatus (caption display control apparatus) according to a thirteenth embodiment of the present invention. When it is judged in step S20 that there is a remaining caption, the first character number judgment J1 is carried out. When it is judged in the first judgment J1 that the character number α of the unit caption (character string) is larger than the reference character number α₀, the font size reduction processing m1 is performed in order to reduce the font size at a unit of basic caption so that the entire character string falls within the display frame area. At that time, the font size is reduced to the minimum size. When the character number α of the unit caption becomes equal to or smaller than the reference character number α₀ as a result of performing the above-described adjustment of the font size, the processing is shifted to step S30 of FIG. 2 without performing the processing m1.

If the entire character string cannot be displayed even after performing the processing m1, the second character number judgment J2 is carried out to judge whether or not the character number α of the unit caption is larger than the second reference character number A. When it is judged as a result that the character number α of the unit caption is larger than the reference character number A, character string paragraph division processing m3 is performed. That is, in order to display the character string within the display frame area without a missing part, the entire character string is divided into partial character strings by each paragraph as shown in FIG. 8. In this processing, there is used a word/phrase dividing function which identifies division point of the words/phrases based on a space, comma, auxiliary word or the like, and divides the character string at the identified division points. The divided number is referred to as “n” hereinafter.

After performing the processing m3, n-times of loop processing are started in step L1, and the caption is outputted in step L2. When display of the partial character strings is completed over n-times, the processing is returned to step S20 of FIG. 2 for performing the remaining caption search. As a result, divided display of the entire character string can be completed within the period of the caption display start/end timing b1.

When it is judged in the judgment J1 that the character number α of the unit caption is equal or smaller than the reference character number α₀, the processing is shifted to step S30 of FIG. 2 without performing the processing m1. When it is judged in the judgment J2 that the character number α of the unit caption (character string) is equal or smaller than the reference character number A, the processing is shifted to step S30 of FIG. 2 without performing the processing m3.

The outline of the embodiment consists of a series of the processing, “the first character number judgment J1—the font size reduction processing m1—the second character number judgment J2—the character string paragraph division processing m3”. This can be simply expressed as “J1-m1-J2-m3”.

### Fourteenth Embodiment

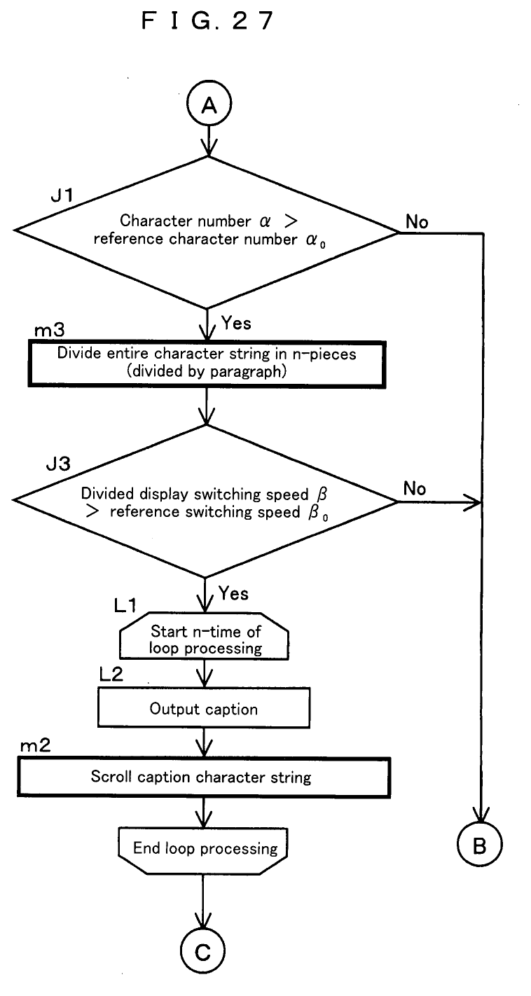

FIG. 27 is a flowchart showing the order of the processing of the caption display control method in the reproducing apparatus (caption display control apparatus) according to a fourteenth embodiment of the present invention. When it is judged in step S20 that there is a remaining caption, the first character number judgment J1 is carried out. When it is judged in the judgment J1 that the character number α of the unit caption (character string) is larger than the reference character number α₀, the character string paragraph division processing m3 is performed. That is, in order to display the entire character string within the display frame area without a missing part, the character string is divided into partial character strings by using the word/phrase dividing function to display each partial character string sequentially within a period of the caption display start/end timing b1.

After performing the processing m3, divided display switching speed judgment J3 is carried out. That is, it is judged whether or not the divided display switching speed β (the speed at which the currently displayed caption is switched to the next display) is faster than a reference switching speed β₀ that is set in advance. The divided display switching speed β can be calculated by dividing the number of characters displayed in one-time display by the period of the caption display start/end timing b1. The user determines the reference switching speed β₀, or it depends upon the reproducing apparatus. When it is judged as a result that the divided display switching speed β is faster than the reference switching speed β₀, n-times of loop processing are started in step L1, and the caption is outputted in step L2. Then, the character string scroll processing m2 is carried out to scroll the caption character string. When the scroll display of the partial character strings is completed over n-times, the processing is returned to step S20 of FIG. 2.

Furthermore, when it is judged in the judgment J1 that the character number α of the unit caption is equal to or smaller than the reference character number α₀, the processing is shifted to step S30 of FIG. 2 without performing the processing m3. When it is judged in the judgment J3 that the divided display switching speed β is the same as or slower than the reference switching speed β₀, the processing is shifted to step S30 of FIG. 2 without performing step L1.

The outline of the embodiment consists of a series of the processing, “the first character number judgment J1—the character string paragraph division processing m3—divided display switching speed judgment J3—the character string scroll processing m2”. This can be simply expressed as “J1-m3 (J3)-m2”.

### Fifteenth Embodiment

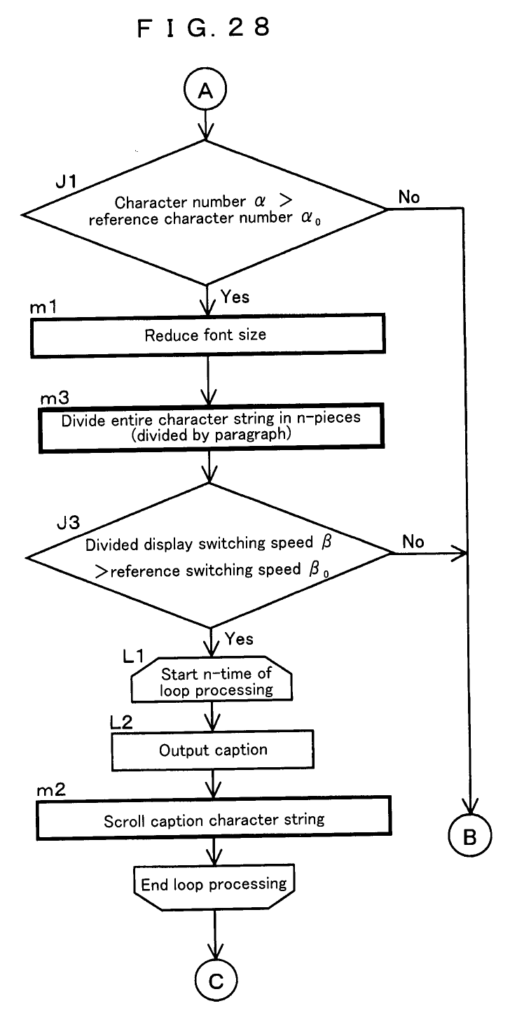

FIG. 28 is a flowchart showing the order of the processing of the caption display control method in the reproducing apparatus (caption display control apparatus) according to a fifteenth embodiment of the present invention. When it is judged in step S20 that there is a remaining caption, the first character number judgment J1 is performed. When it is judged in the judgment J1 that the character number α of the unit caption is larger than the reference character number α₀, the font size reduction processing m1 is performed in order to reduce the font size so that the character string can be displayed within the display frame area without a missing part.

If the font size needs to be made smaller than the minimum size defined in advance even after performing the processing m1, the character string paragraph division processing m3 is carried out. That is, the character string is divided into partial character strings by using the word/phrase dividing function to display each partial character string sequentially within a period of the caption display start/end timing b1.

After performing the processing m3, divided display switching speed judgment J3 is carried out in order to judge whether or not the divided display switching speed β is faster than the reference switching speed β₀. When the divided display switching speed β is faster than the reference switching speed β₀, n-times of loop processing are started in step L1, and the caption is outputted in step L2. Then, the character string scroll processing m2 is carried out to scroll the caption character strings (partial character strings). When the scroll display of the partial character strings is completed over n-times, the processing is returned to step S20 to perform remaining caption search.

Farther, when it is judged in the judgment J1 that the character number α of the unit caption (character string) is equal to or smaller than the reference character number α₀, the processing is shifted to step S30 of FIG. 2 without performing the processing m1. When it is judged in the judgment J3 that the divided display switching speed β is the same as or slower than the reference switching speed β₀, the processing is shifted to step S30 of FIG. 2 without performing the scroll processing of the partial character strings.

The outline of the embodiment consists of a series of the processing, “the first character number judgment J1—the font size reduction processing m1—the character string clause punctuation processing m3—divided display switching speed judgment J3—the character string scroll processing m2”. This can be simply expressed as “J1-ml-m3 (J3)-m2”.

### Sixteenth Embodiment

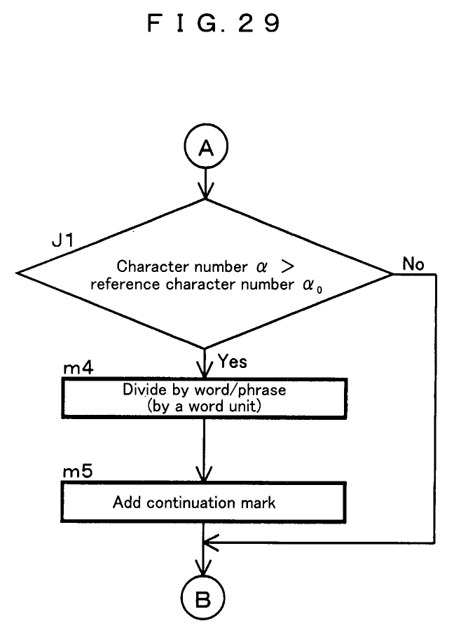

FIG. 29 is a flowchart showing the order of the processing of the caption display control method in the reproducing apparatus (caption display control apparatus) according to a sixteenth embodiment of the present invention. When it is judged in step S20 that there is a remaining caption, the first character number judgment J1 is carried out. When it is judged in the first judgment J1 that the character number α of the unit caption (character string) is larger than the reference character number α₀, character string word unit dividing processing m4 is performed. That is, in order to inform the user that there is a continued part in the caption, the caption character string is divided into a displayable partial character string and non-displayable partial character string by a word unit through using the word/phrase dividing function. Then, continuation mark adding processing m5 is performed to display the displayable partial character string after further adding a continuation mark (e.g. “ - - - ” indicating that there is a continued part in the caption) to the displayable partial character string at the end thereof. After performing the above-described processing, it is shifted to step S30 of FIG. 2. When it is judged in the judgment J1 that the character number α of the unit caption is equal to or smaller than the reference character number α₀, it is shifted to step S30 of FIG. 2 without performing the processing m4 and the processing m5.

The outline of the embodiment consists of a series of the processing, “the first character number judgment J1—the character string word unit dividing processing m4—the continuation mark adding processing m5”. This can be simply expressed as “J1-m4-m5”.

### Seventeenth Embodiment

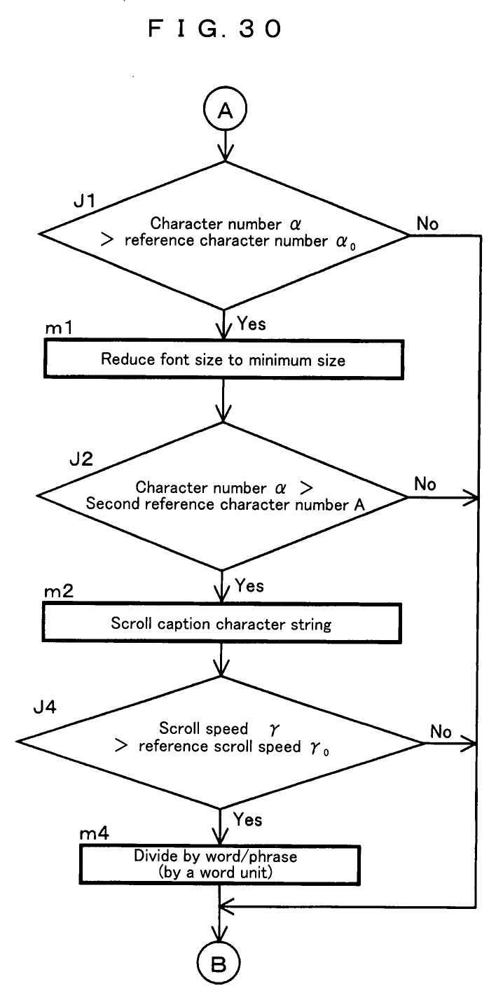

FIG. 30 is a flowchart showing the order of the processing of the caption display control method in the reproducing apparatus (caption display control apparatus) according to a seventeenth embodiment of the present invention. When it is judged in step S20 that there is a remaining caption, the first character number judgment J1 is carried out. When it is judged in the judgment J1 that the character number α of the unit caption is larger than the reference character number α₀, the font size reduction processing m1 is performed to reduce the font size by the basic caption (character string) unit in order to display the character string within the display frame area without a missing part. At that time, the font size is reduced to the minimum size.

If the entire character string cannot be displayed even after reducing the font size to the minimum size, the second character number judgment J2 is carried out to judge whether or not the character number α of the unit caption (character string) is larger than the reference character number A. When the character number α of the unit caption (character string) is larger than the reference character number A, the character string scroll processing m2 is performed to scroll-display the character strings.

After performing the processing m2, scroll speed judgment J4 is carried out. That is, it is judged whether or not the scroll speed γ is faster than a reference scroll speed γ₀ that is defined in advance. The scroll speed γ indicates the speed at which the remaining number of characters can be displayed within the period of the caption display start/end timing b1. The reference scroll speed γ₀ is determined by the user or defined in accordance with the performance of the reproducing apparatus. When the scroll speed γ is faster than the reference scroll speed γ₀, the character string word unit dividing processing m4 is performed to divide the caption character string into a word unit through the use of the word/phrase dividing function so that the caption is displayed without being ended in a halfway. After performing the above-described processing, it is shifted to step S30 of FIG. 2.

Moreover, when it is judged in the judgment J1 that the character number α of the unit caption is equal to or smaller than the reference character number α₀, the processing is shifted to step S30 of FIG. 2 without performing the processing m1. When it is judged in the judgment J2 that the character number α of the unit caption is equal to or smaller than the second reference character number A, the processing is shifted to step S30 of FIG. 2 without performing the processing m2. When it is judged in the judgment J4 that the scroll speed γ is the same as or slower than the reference scroll speed γ₀, it is shifted to step S30 of FIG. 2 without performing the processing m4.

The outline of the embodiment consists of a series of the processing, “the first character number judgment J1—the font size reduction processing m1—the second character number judgment J2—the character string scroll processing m2—the scroll speed judgment J4—the character string word unit dividing processing m4”. This can be simply expressed as “J1-m1-J2-m2-J4-m4”.

### Eighteenth Embodiment

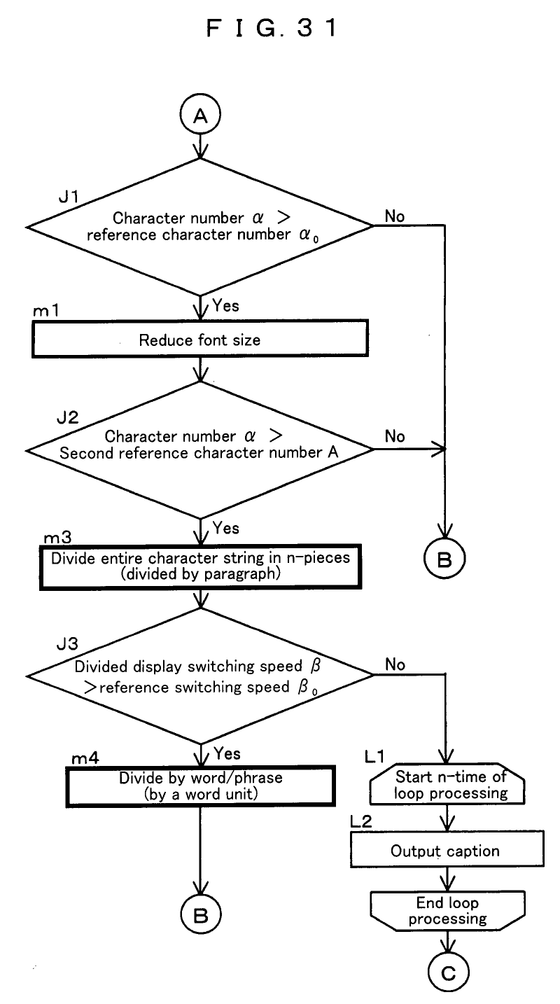

FIG. 31 is a flowchart showing the order of the processing of the caption display control method in the reproducing apparatus (caption display control apparatus) according to an eighteenth embodiment of the present invention. When it is judged in step S20 that there is a remaining caption, the first character number judgment J1 is carried out. In the judgment J1, when the character number α of the unit caption (character string) is larger than the reference character number α₀, the font size reduction processing m1 is performed to reduce the font size by the basic caption unit in order to display the character string within the display frame area without a missing part. At that time, the font size is reduced to the minimum size. Furthermore, when the character number a of the unit caption is equal or smaller than the reference character number α₀, the processing is shifted to step S30 of FIG. 2 without performing the processing m1.

If the entire character string cannot be displayed even after performing the above-described processing, the second character number judgment J2 is carried out to judge whether or not the character number α of the unit caption (character string) is larger than the second reference character number A. When the character number α of the unit caption is larger than the reference character number A, the character string paragraph division processing m3 is performed to divide the character string into the partial character strings. Thereafter, the divided display switching speed judgment J3 is carried out to judge whether or not the divided display switching speed β is faster than a reference switching speed β₀. When the divided display switching speed β is faster than the reference switching speed β₀, the character string word unit dividing processing m4 is performed to divide the caption character string (partial character string) into the partial character string areas by a word unit through the use of the word/phrase dividing function so that the caption (partial character string area) can be displayed without being ended in a halfway. Thereafter, the processing is shifted to step S30 of FIG. 2.

When the divided display switching speed β is equal to or slower than the reference switching speed β₀, each of the partial character strings is displayed. That is, n-times of loop processing are started in step L1, and the caption (partial character strings) is outputted in step L2. When the display of the partial character strings over n-times is completed, the processing is returned to step S20 of FIG. 2.

Moreover, when it is judged in the judgment J1 that the character number α of the unit caption is equal to or smaller than the reference character number α₀, the processing is shifted to step S30 of FIG. 2 without performing the processing m1. When it is judged in the judgment J2 that the character number α of the unit caption is equal to or smaller than the second reference character number A, it is shifted to step S30 of FIG. 2.

The outline of the embodiment consists of a series of the processing, “the first character number judgment J1—the font size reduction processing m1—the second character number judgment J2—the character string clause punctuation processing m3—the divided display switching speed judgment J3—the character string word unit dividing processing m4”. This can be simply expressed as “J1-m1-J2-m3 (J3)-m4”.

### Nineteenth Embodiment

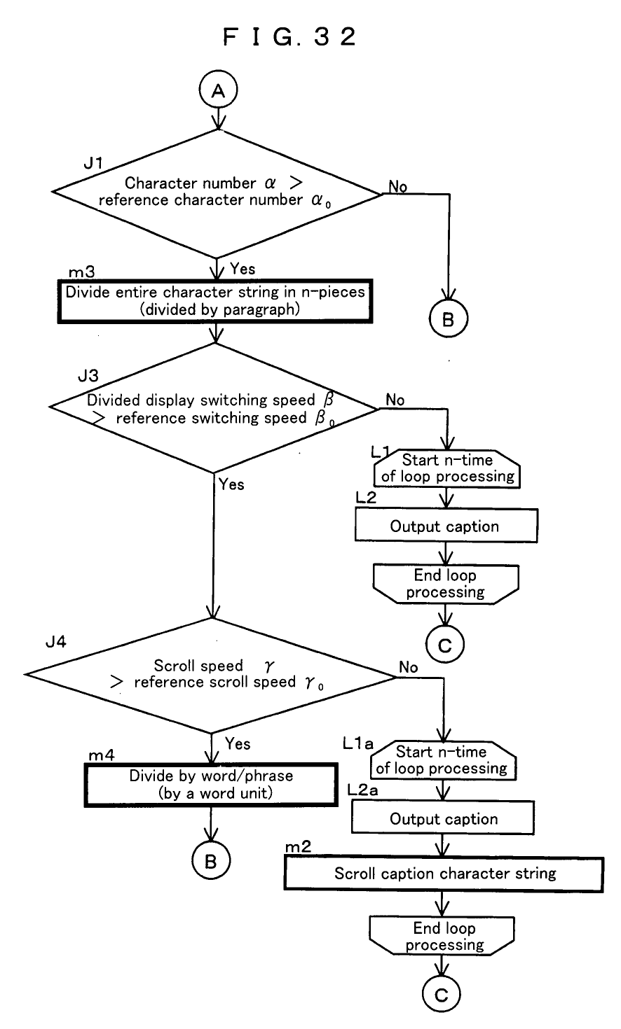

FIG. 32 is a flowchart r showing the order of the processing of the caption display control method in the reproducing apparatus (caption display control apparatus) according to a nineteenth embodiment of the present invention. When it is judged in step S20 that there is a remaining caption, the first character number judgment J1 is carried out. When it is judged in the judgment J1 that the character number α of the unit caption (character string) is larger than the reference character number α₀, the character string paragraph division processing m3 is performed to divide the character string into the partial character strings through the use of the word/phrase dividing function in order to display the character string within the display frame area without a missing part.

After performing the processing m3, the divided display switching speed judgment J3 is carried out to judge whether or not the divided display switching speed β is faster than the reference switching speed β₀. When the divided display switching speed β is equal to or slower than the reference switching speed β₀, each of the partial character strings is displayed. That is, n-times of loop processing are started in step L1, and the caption (partial character strings) is outputted in step L2. When the display of the partial character strings over n-times is completed, the processing is returned to step S20 of FIG. 2. The reference switching speed β₀ is the switching seed serving as the reference of the display switching speed in switching and displaying the partial character strings sequentially, and it is the upper-limit switching speed at which each of the character strings can be visually recognized.

In the judgment J3, when the divided display switching speed β is faster than a reference switching speed β₀, the scroll speed judgment J4 is carried out to judge whether or not the scroll speed γ is faster than the reference scroll speed γ₀. When the scroll speed γ is faster than the reference scroll speed γ₀, the character string word unit dividing processing m4 is performed to divide the partial character string into the partial character string areas by a word unit through the use of the word/phrase dividing function so that the caption is displayed without ending the character string in a halfway. Thereafter, the processing is shifted to step S30 of FIG. 2.

the judgment J4, when the scroll speed γ is equal to or slower than the reference scroll speed γ₀, scroll processing L1a, L2a, m2 of the partial character string areas are carried out over n-times to scroll-display the partial character string areas. After completing the scroll-display over n-times, the processing is returned to step S20 of FIG. 2.

When it is judged in the judgment J1 that the character number α of the unit caption is equal to or smaller than the reference character number α₀, the processing is shifted to step S30 of FIG. 2 without performing the processing m3.

The outline of the embodiment consists of a series of the processing, “the first character number judgment J1—the character string clause punctuation processing m3—the divided display switching speed judgment J3—the character string scroll processing m2—the scroll speed judgment J4—the character string word unit dividing processing m4”. This can be simply expressed as “J1-m3 (J3)-m2-J4-m4”.

### Twentieth Embodiment

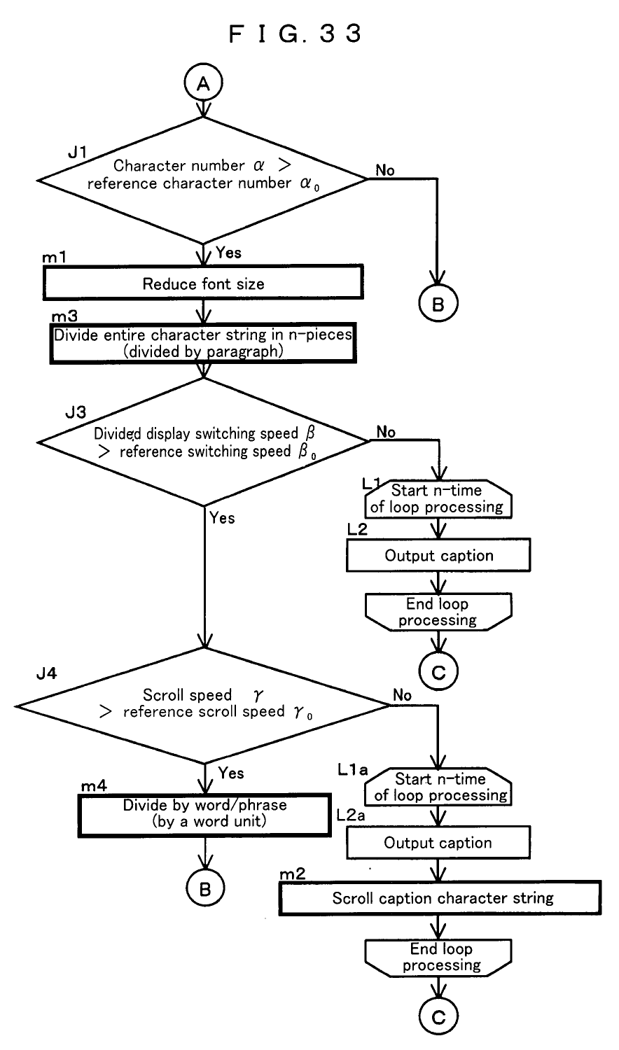

FIG. 33 is a flowchart showing the order of the processing of the caption display control method in the reproducing apparatus (caption display control apparatus) according to a twentieth embodiment of the present invention. When it is judged in step S20 that there is a remaining caption, the first character number judgment J1 is performed. In the judgment J1, when the character number α of the unit caption (character string) is larger than the reference character number α₀, the font size reduction processing m1 is performed in order to reduce the font size of the displayed caption so that the character string can be displayed in the display frame area without a missing part. If the font size needs to be made smaller than the minimum size that is defined in advance even after performing the processing m1, the character string paragraph division processing m3 is carried out. That is, the character string is divided into partial character strings by using the word/phrase dividing function to display each partial character string sequentially within the caption display start/end timing b1.

Then, the divided display switching speed judgment J3 is carried out in order to judge whether or not the divided display switching speed β is faster than the reference switching speed β₀. When the divided display switching speed β is faster than the reference switching speed β₀, the scroll speed judgment J4 is carried out in order to judge whether or not the scroll speed γ is faster than the reference scroll speed γ₀. When the scroll speed γ is faster than the reference scroll speed γ₀, the character string word unit dividing processing m4 is performed to divide the caption character string (partial character string) into the partial character string areas by a word unit through using the word/phrase dividing function so that the each of the partial character string areas can be displayed as the caption without ending in a halfway. Thereafter, it is shifted to step S30 of FIG. 2.

In the judgment J1, when the character number α of the unit caption is equal or smaller than the reference character number α₀, the processing is shifted to step S30 of FIG. 2.

When it is judged in the judgment J3 that the divided display switching speed β is equal or slower than the reference switching speed β₀, each of the partial character strings is displayed in order of precedence. That is, n-times of loop processing are started in step L1, and the partial character strings are outputted in step L2. When the display of the partial character strings over n-times is completed, the processing is returned to step S20 of FIG. 2.

In the judgment J4, when the scroll speed γ is equal to or slower than the reference scroll speed γ₀, the character scroll processing m2 is carried out to scroll-display each of the partial character strings. After completing the scroll-display over n-times, the processing is returned to step S20 of FIG. 2.

The outline of the embodiment consists of a series of the processing, “the first character number judgment J1—the font size reduction processing m1—the character string clause punctuation processing m3—the divided display switching speed judgment J3—the character string scroll processing m2—the scroll speed judgment J4—the character string word unit dividing processing m4”. This can be simply expressed as “J1-m1-m3 (J3)-m2-J4-m4”.

### Twenty-First Embodiment

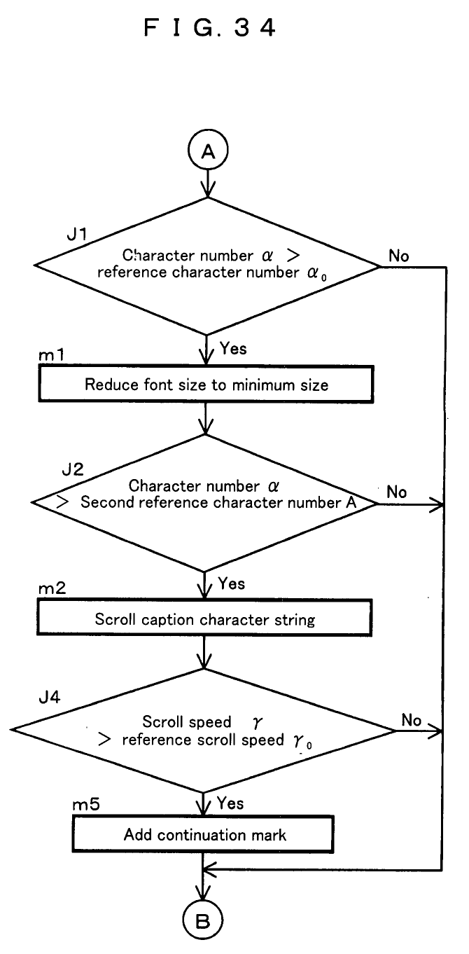

FIG. 34 is a flowchart showing the order of the processing of the caption display control method in the reproducing apparatus (caption display control apparatus) according to a twenty-first embodiment of the present invention. When it is judged in step S20 that there is a remaining caption, the first character number judgment J1 is carried out. When it is judged in the judgment J1 that the character number α of the unit caption (character string) is larger than the reference character number α₀, the font size reduction processing m1 is performed to reduce the font size to the minimum size by the basic caption unit in order to display the character string within the display frame area without a missing part.

After performing the processing m1, the second character number judgment J2 is carried out to judge whether or not the character number α of the unit caption (character string) is larger than the second reference character number A. When the character number α of the unit caption is larger than the reference character number A, the character string scroll processing m2 is performed to scroll-display the character string.

After performing the processing m2, scroll speed judgment J4 is carried out in order to judge whether or not the scroll speed γ is faster than the reference scroll speed γ₀. When the scroll speed γ is faster than the reference scroll speed γ₀, the continuation mark adding processing m5 is performed. That is, the caption is displayed by adding a continuation mark such as “ - - - ” at the end of the character string, indicating that there is a continued part in the caption. The reference switching speed β is the switching seed serving as the reference of the display switching speed when switching and displaying the partial character strings sequentially, and it is the upper-limit switching speed at which each of the character strings can be visually recognized. The processing is shifted to step S30 of FIG. 2 thereafter.

In the judgment J1, when the character number α of the unit caption is equal or smaller than the reference character number α₀, the processing is shifted to step S30 of FIG. 2 without performing the processing m1. When it is judged in the judgment J2 that the character number α of the unit caption is equal to or smaller than the second reference character number A, the processing is shifted to step S30 of FIG. 2 without performing the processing m2. In the judgment J4, when the scroll speed γ is the same or slower than the reference scroll speed γ₀, it is shifted to step S30 of FIG. 2 without performing the processing m5.

The outline of the embodiment consists of a series of the processing, “the first character number judgment J1—the font size reduction processing m1—the second character number judgment J2—the character string scroll processing m2—the scroll speed judgment J4—the continuation mark adding processing m5”. This can be simply expressed as “J1-m1-J2-m2-J4-m5”.

### Twenty-Second Embodiment

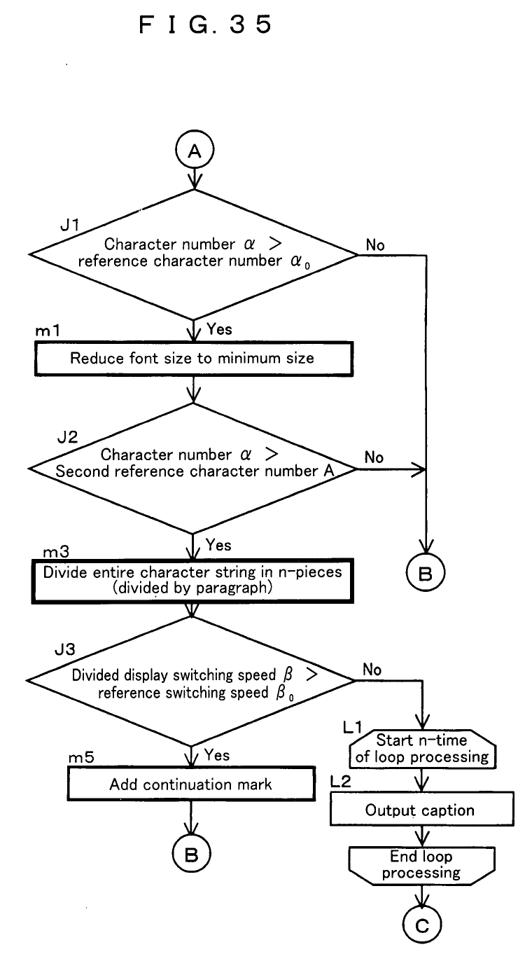

FIG. 35 is a flowchart showing the order of the processing of the caption display control method in the reproducing apparatus (caption display control apparatus) according to a twenty-second embodiment of the present invention. When it is judged in step S20 that there is a remaining caption, the first character number judgment J1 is carried out. In the judgment J1, when the character number α of the unit caption (character string) is larger than the reference character number α₀, the font size reduction processing m1 is performed to reduce the font size by the basic caption unit in order to display the character string within the display frame area without a missing part.

After performing the processing m1, the second character number judgment J2 is carried out to judge whether or not the character number α of the unit caption (character string) is larger than the second reference character number A. When the character number α of the unit caption is larger than the reference character number A, the character string paragraph division processing m3 is performed to divide the character string into the partial character strings.

After performing the processing m3, the divided display switching speed judgment J3 is carried out to judge whether or not the divided display switching speed β is faster than the reference switching speed β₀. When the divided display switching speed β is faster than the reference switching speed β₀, the continuation mark adding processing m5 is performed to display the caption by adding a continuation mark such as “ - - - ” at the end of the character string, indicating that there is a continued part in the caption. Thereafter, the processing is shifted to step S30 of FIG. 2.

In the judgment J3, when the divided display switching speed β is equal to or slower than the reference switching speed β₀, each of the partial character strings is displayed in order of precedence. That is, n-times of loop processing are started in step L1, and the caption (partial character string) is outputted in step L2. When the scroll display of the partial character strings over n-times is completed, the processing is returned to step S20 of FIG. 2.

Furthermore, when it is judged in the judgment J1 that the character number α of the unit caption is equal to or smaller than the reference character number α₀, the processing is shifted to step S30 of FIG. 2 without performing the processing m1. In the judgment J2, when the character number α of the unit caption is equal to or smaller than the second reference character number A, it is shifted to step S30 of FIG. 2 without performing the processing m3.

The outline of the embodiment consists of a series of the processing, “the first character number judgment J1—the font size reduction processing m1—the second character number judgment J2—the character string clause punctuation processing m3—the divided display switching speed judgment J3—the continuation mark adding processing m5”. This can be simply expressed as “J1-m1-J2-m3 (J3)-m5”.

### Twenty-Third Embodiment

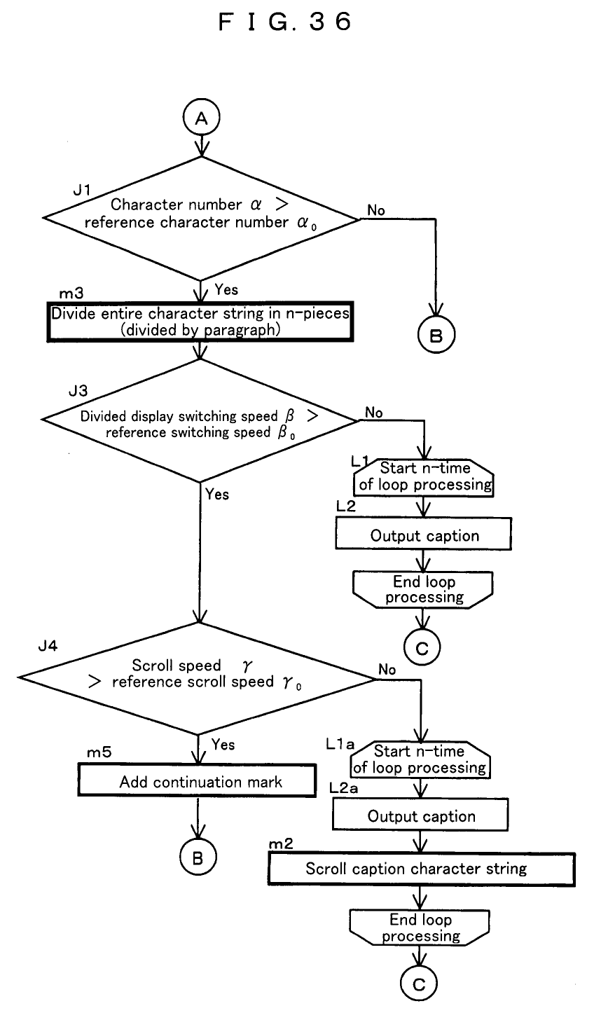

FIG. 36 is a flowchart showing the order of the processing of the caption display control method in the reproducing apparatus according to a twenty-third embodiment of the present invention. When it is judged in step S20 that there is a remaining caption, the first character number judgment J1 is carried out. In the judgment J1, when the character number α of the unit caption (character string) is larger than the reference character number α₀, the character string paragraph division processing m3 is performed. That is, the character string is divided into the partial character strings by the basic caption unit for display.

After performing the processing m3, the divided display switching speed judgment J3 is carried out to judge whether or not the divided display switching speed β is faster than the reference switching speed β₀. When the divided display switching speed β is faster than the reference switching speed β₀, the scroll speed judgment J4 is carried out to judge whether or not the scroll speed γ is faster than the reference scroll speed γ₀. When the scroll speed γ is faster than the reference scroll speed γ₀, the continuation mark adding processing m5 is performed to display the caption by adding a continuation mark such as “ - - - ” at the end of the character string, indicating that there is a continued part in the caption. Thereafter, the processing is shifted to step S30 of FIG. 2.

In the judgment J1, when the character number α of the unit caption (partial character string) is equal to or smaller than the reference character number α₀, the processing is shifted to step S30 of FIG. 2 without performing the processing m1.

In the judgment J3, when the divided display switching speed β is equal to or slower than the reference switching speed β₀, each of the partial character strings is displayed in order. That is, n-times of loop processing are started in step L1, and the partial character strings are outputted in step L2. When the scroll display of the partial character strings over n-times is completed, the processing is returned to step S20 of FIG. 2.

In the judgment J4, when the scroll speed γ is equal or slower than the reference scroll speed γ₀, the character scroll processing L1a, L2a, m2 is carried out to scroll-display the partial character strings. After completing the scroll-display over n-times, the processing is returned to step S20 of FIG. 2.

The outline of the embodiment consists of a series of the processing, “the first character number judgment J1—the character string clause punctuation processing m3—the divided display switching speed judgment J3—the character string scroll processing m2—the scroll speed judgment J4—the continuation mark adding processing m5”. This can be simply expressed as “J1-m3 (J3)-m2-J4-m5”.

### Twenty-Fourth Embodiment

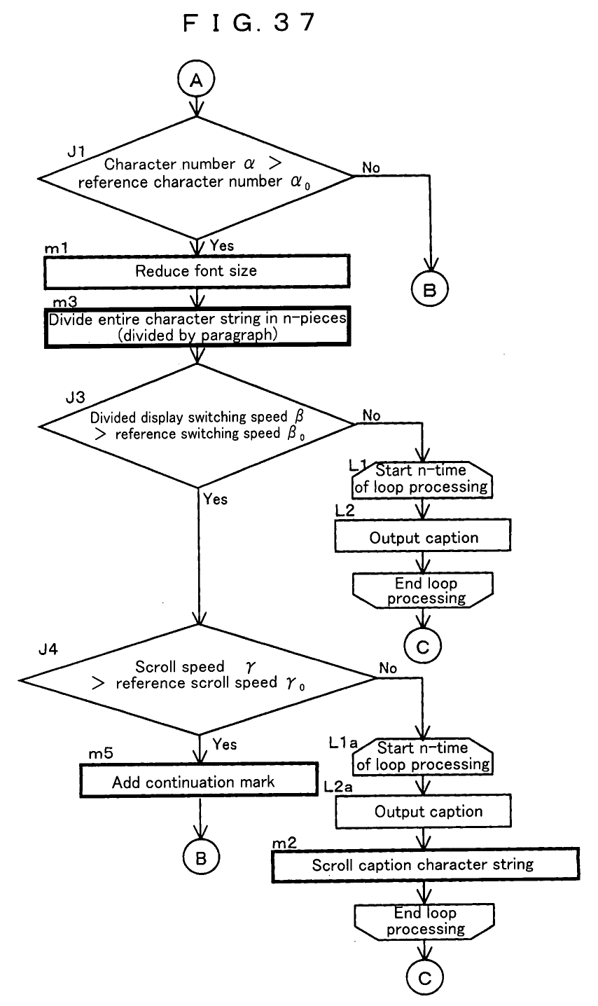

FIG. 37 is a flowchart showing the order of the processing of the caption display control method in the reproducing apparatus (caption display control apparatus) according to a twenty-fourth embodiment of the present invention. When it is judged in step S20 that there is a remaining caption, the first character number judgment J1 is carried out. When it is judged in the judgment J1 that the character number α of the unit caption (character string) is larger than the reference character number α₀, the font size reduction processing m1 is performed. That is, the font size is reduced based on the basic caption (character string) unit in order to display the character string within the display frame area by the basic caption unit without a missing part. Furthermore, the character string paragraph division processing m3 is carried out. That is, when the font size must be made smaller than the minimum size, the character string is divided into partial character strings by using the word/phrase dividing function to display each partial character string separating in the number of times within the caption display start/end timing b1.

After performing the processing m3, the divided display switching speed judgment J3 is carried out to judge whether or not the divided display switching speed β is faster than the reference switching speed β₀. When the divided display switching speed β is faster than the reference switching speed β₀, the scroll speed judgment J4 is carried out in order to judge whether or not the scroll speed γ is faster than the reference scroll speed γ₀. When the scroll speed γ is faster than the reference scroll speed γ₀, the continuation mark adding processing m5 is performed to display the caption by adding a continuation mark such as “ - - - ” at the end of the caption (the character string), indicating that there is a continued part in the caption. Thereafter, the processing is shifted to step S30 of FIG. 2.

In the judgment J1, when the character number α of the unit caption (character string) is equal to or smaller than the reference character number α₀, the processing is shifted to step S30 of FIG. 2 without performing the processing m1 and the processing m2.

In the judgment J3, when the divided display switching speed β is equal or slower than the reference switching speed β₀, each of the partial character strings is displayed sequentially. That is, n-times of loop processing are started in step L1, and the caption (partial character strings) is outputted in step L2. When the display of the partial character strings over n-times is completed, the processing is returned to step S20 of FIG. 2.

In the judgment J4, when the scroll speed γ is equal to or slower than the reference scroll speed γ₀, the character scroll processing L1a, L2a, m2 is carried out to scroll-display the caption character string (partial character strings). After completing the scroll-display over n-times, the processing is returned to step S20 of FIG. 2.

The outline of the embodiment consists of a series of the processing, “the first character number judgment J1—the font size reduction processing m1—the character string clause punctuation processing m3—the divided display switching speed judgment J3—the character string scroll processing m2—the scroll speed judgment J4—the continuation mark adding processing m5”. This can be simply expressed as “J1-m1-m3 (J3)-m2-J4-m5”.

### Twenty-Fifth Embodiment

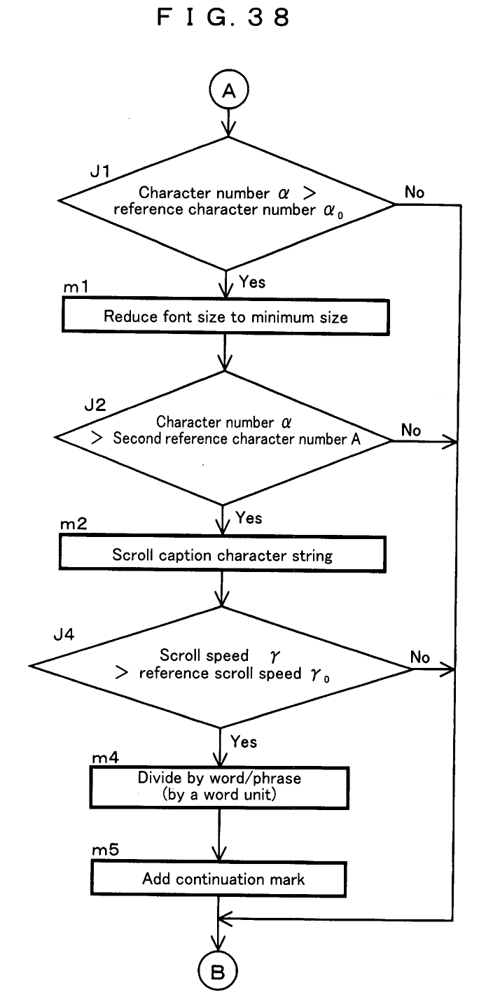

FIG. 38 is a flowchart showing the order of the processing of the caption display control method in the reproducing apparatus (caption display control apparatus) according to a twenty-fifth embodiment of the present invention. When it is judged in step S20 that there is a remaining caption, the first character number judgment J1 is carried out. When it is judged in the judgment J1 that the character number α of the unit caption (character string) is larger than the reference character number α₀, the font size reduction processing m1 is performed to reduce the font size to the minimum size by the basic caption (character string) unit in order to display the character string within the display frame area without a missing part. At that time, the font size is reduced to the minimum size that is defined in advance.

Thereafter, the second character number judgment J2 is carried out. That is, it is judged here whether or not the character number α of the unit caption (character string) is larger than the second reference character number A. When the character number α of the unit caption is larger than the reference character number A, the character string scroll processing m2 is performed to scroll-display the character string.

After performing the processing m2, the scroll speed judgment J4 is carried out. That is, it is judged whether or not the scroll speed γ is faster than the reference scroll speed γ₀. When the scroll speed γ is faster than the reference scroll speed γ₀, the character string word unit dividing processing m4 is performed to divide the character string by a word unit through the use of the word/phrase dividing function so that the caption is displayed without having the partial character string ended in a halfway. Furthermore, the continuation mark adding processing m5 is performed to display the caption by adding a continuation mark such as “ - - - ” at the end of the partial character string, indicating that there is a continued part in the caption. After performing the processing m5, the processing is returned to step S20 of FIG. 2.

In the judgment J1, when the character number α of the unit caption (character string) is equal to or smaller than the reference character number α₀, the processing is shifted to step S30 of FIG. 2 without performing the processing m1.

In the judgment J2, when the character number α of the unit caption (character string) is equal to or smaller than the second reference character number A, the processing is shifted to step S30 of FIG. 2 without performing the processing m3.

When judged in the judgment J4 that the scroll speed γ is the same or slower than the reference scroll speed γ₀, it is shifted to step S30 of FIG. 2 without performing the processing m4 and the processing m5.

The outline of the embodiment consists of a series of the processing, “the first character number judgment J1—the font size reduction processing m1—the second character number judgment J2—the character string scroll processing m2—the scroll speed judgment J4—the character string word unit dividing processing m4—the continuation mark adding processing m5”. This can be simply expressed as “J1-m1-J2-m2-J4-m4-m5”.

### Twenty-Sixth Embodiment

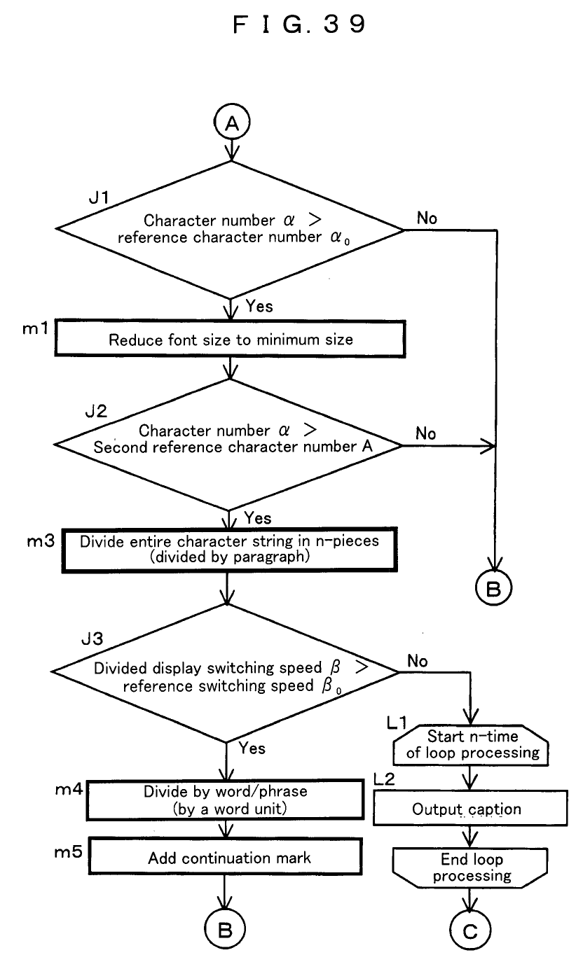

FIG. 39 is a flowchart showing the order of the processing of the caption display control method in the reproducing apparatus (caption display control apparatus) according to a twenty-sixth embodiment of the present invention. When it is judged in step S20 that there is a remaining caption, the first character number judgment J1 is carried out. When it is judged in the judgment J1 that the character number α of the unit caption (character string) is larger than the reference character number α₀, the font size reduction processing m1 is performed to reduce the font size to the minimum size by the basic caption unit in order to display the character string within the display frame area without a missing part.

Then, the second character number judgment J2 is carried out. That is, it is judged whether or not the character number α of the unit caption (character string) is larger than the second reference character number A. When the character number α of the unit caption is larger than the reference character number A, the character string paragraph division processing m3 is performed to divide the character string into the partial character strings by a paragraph unit.

Next, the divided display switching speed judgment J3 is carried out to judge whether or not the divided display switching speed β is faster than a reference switching speed β₀. When the divided display switching speed β is faster than the reference switching speed β₀, the character string word unit dividing processing m4 is performed to divide the partial character string into the partial character string areas by a word unit through the use of the word/phrase dividing function so that the caption can be displayed without being ended in a halfway.

Furthermore, the continuation mark adding processing m5 is performed to display the caption by adding a continuation mark such as “ - - - ” at the end of the partial character string area, indicating that there is a continued part in the caption. Thereafter, the processing is shifted to step S30 of FIG. 2.

In the judgment J1, when the character number α of the unit caption (character string) is equal to or smaller than the reference character number α₀, the processing is shifted to step S30 of FIG. 2 without performing the processing m1.

In the judgment J2, when the character number α of the unit caption (character string) is equal to or smaller than the second reference character number A, it is shifted to step S30 of FIG. 2 without performing the processing m3.

In the judgment J3, when the divided display switching speed β is equal to or slower than the reference switching speed β₀, each of the partial character strings is displayed in order of precedence. That is, n-times of loop processing are started in step L1, and the partial character strings are outputted in step L2. When the scroll display of the partial character strings over n-times is completed, the processing is returned to step S20 of FIG. 2.

The outline of the embodiment consists of a series of the processing, “the first character number judgment J1—the font size reduction processing m1—the second character number judgment J2—the character string clause punctuation processing m3—the divided display switching speed judgment J3—the character string word unit dividing processing m4—the continuation mark adding processing m5”. This can be simply expressed as “J1-m1-J2-m3 (J3)-m4-m5”.

### Twenty-Seventh Embodiment

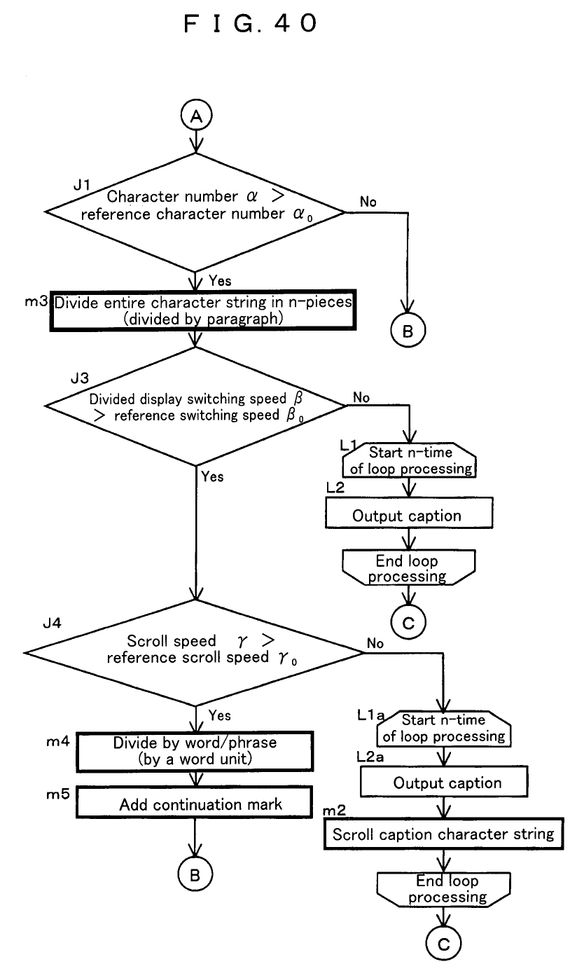

FIG. 40 is a flowchart showing the order of the processing of the caption display control method in the reproducing apparatus (caption display control apparatus) according to a twenty-seventh embodiment of the present invention. When it is judged in step S20 that there is a remaining caption, the first character number judgment J1 is carried out. When it is judged in the judgment J1 that the character number α of the unit caption (character string) is larger than the reference character number α₀, the character string paragraph division processing m3 is performed to divide the character string into the partial character strings by the basic caption unit through the use of the word/phrase dividing function to display each of the partial character strings.

Furthermore, the divided display switching speed judgment J3 is carried out to judge whether or not the divided display switching speed β is faster than the reference switching speed β₀. When the divided display switching speed β is faster than the reference switching speed β₀, the scroll speed judgment J4 is carried out to judge whether or not the scroll speed γ is faster than the reference scroll speed γ₀. When the scroll speed γ is faster than the reference scroll speed γ₀, the character string word unit dividing processing m4 is performed. That is, the partial character string is divided into partial character string areas by a word unit through the use of the word/phrase dividing function so that each of the character string areas is displayed without ending the displayed caption in a halfway. Further, the continuation mark adding processing m5 is performed to display the caption by adding a continuation mark such as “ - - - ” at the end of the partial character string area, indicating that there is a continued part in the caption. Thereafter, the processing is shifted to step S30 of FIG. 2.

In the judgment J1, when the character number α of the unit caption is equal to or smaller than the reference character number α₀, the processing is shifted to step S30 of FIG. 2 without performing the processing m3.

In the judgment J3, when the divided display switching speed β is equal to or slower than the reference switching speed β₀, each of the partial character strings is displayed sequentially. That is, n-times of loop processing are started in step L1, and the partial character strings are outputted in step L2. When the scroll display of the partial character strings over n-times is completed, the processing is returned to step S20 of FIG. 2.

In the judgment J4, when the scroll speed γ is equal to or slower than the reference scroll speed γ₀, the character scroll processing L1a, L2a, m2 is carried out to scroll-display the partial character strings. After completing the scroll-display over n-times, the processing is returned to step S20 of FIG. 2.

The outline of the embodiment consists of a series of the processing, “the first character number judgment J1—the character string clause punctuation processing m3—the divided display switching speed judgment J3—the character string scroll processing m2—the scroll speed judgment J4—the character string word unit dividing processing m4—the continuation mark adding processing m5”. This can be simply expressed as “J1-m3-(J3)-m2-J4-m4-m5”.

### Twenty-Eighth Embodiment

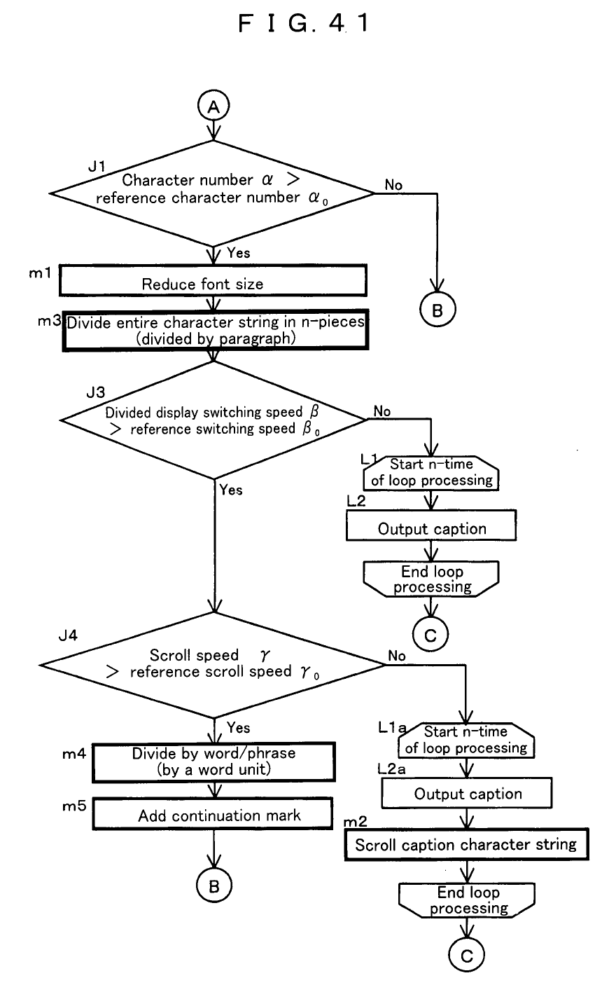

FIG. 41 is a flowchart showing the order of the processing of the caption display control method in the reproducing apparatus (caption display control apparatus) according to a twenty-eighth embodiment of the present invention. When it is judged in step S20 that there is a remaining caption, the first character number judgment J1 is carried out. When it is judged in the judgment J1 that the character number α of the unit caption (character string) is larger than the reference character number α₀, the font size reduction processing m1 is performed to reduce the font size by the basic caption (character string) unit in order to display the character string within the display frame area by the basic caption unit without a missing part. Then, in cases where the character string paragraph division processing m3 is performed and the font size has to be made smaller than the pre-defined minimum size, the character string is divided into partial character strings by using the word/phrase dividing function to display each partial character string in order of precedence within the caption display start/end timing b1.

Then, the divided display switching speed judgment J3 is carried out to judge whether or not the divided display switching speed β is faster than the reference switching speed β₀. When the divided display switching speed β is faster than the reference switching speed β₀, the scroll speed judgment J4 is carried out to judge whether or not the scroll speed γ is faster than the reference scroll speed γ₀. When the scroll speed γ is faster than the reference scroll speed γ₀, the character string word unit dividing processing m4 is performed. That is, the caption character string (partial character string) is divided into partial character string areas by a word unit through the use of the word/phrase dividing function so that each of the character string areas is displayed without ending the displayed caption in a halfway. Further, the continuation mark adding processing m5 is performed to display the caption by adding a continuation mark such as “ - - - ” at the end of the partial character string areas, indicating that there is a continued part in the caption. Thereafter, the processing is shifted to step S30 of FIG. 2.

In the judgment J1, when the character number α of the unit caption (character string) is equal to or smaller than the reference character number α₀, the processing is shifted to step S30 of FIG. 2 without performing the processing m3.

In the judgment J3, when the divided display switching speed β is equal to or slower than the reference switching speed β₀, the partial character sting is divided by using the word/phrase dividing function for display. That is, n-times of loop processing are started in step L1, and the caption is out putted in step L2. When the caption display over n-times by a paragraph unit is completed, the processing is returned to step S20 of FIG. 2.

When it is judged in the judgment J4 that the scroll speed γ is equal or slower than the reference scroll speed γ₀, the character scroll processing L1a, L2a, m2 is carried out to scroll-display the partial character strings. After completing the scroll-display of the partial character strings over n-times, the processing is returned to step S20 of FIG. 2.

The outline of the embodiment consists of a series of the processing, “the first character number judgment J1—the font size reduction processing m1—the character string clause punctuation processing m3—the divided display switching speed judgment J3—the character string scroll processing m2—the scroll speed judgment J4—the character string word unit dividing processing m4—the continuation mark adding processing m5”. This can be simply expressed as “J1-m1-m3-(J3)-m2-J4-m4-m5”.

### Twenty-Ninth Embodiment

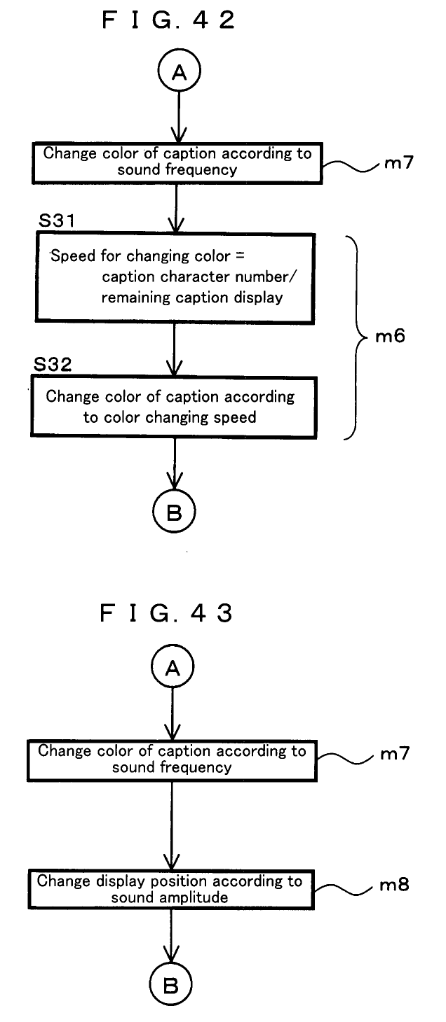

FIG. 42 is a flowchart showing the order of the processing of the caption display control method in the reproducing apparatus (caption display control apparatus) according to a twenty-ninth embodiment of the present invention. When it is judged in step S20 that there is a remaining caption, the caption color changing processing m7 is performed. That is, in order to display the caption in the optimum way in all the scenes by using colors, the color of the caption is changed in accordance with the frequency of the sound based on the sound information of the video/audio data 2.

Then, the caption color scroll processing m6 is performed. That is, first, the number of remaining caption characters is divided by-the caption display period in step S31 to obtain the speed for changing the color (color changing speed) in accordance with the reproducing time of the video/audio data 2, in order to display the caption in the optimum way in all the scenes by using colors. Thereafter, in step S32, the color of the caption is changed from the displayed forehand character at the obtained color changing speed. After performing the step S32, it is shifted to step S30 of FIG. 2.

As shown in FIG. 14, this embodiment enables the user to grasp the current state by simply looking at the caption through coloring the reproduced caption display part in gray or the like. In addition, when expressing the conversation between a man and a woman as shown in FIG. 16, it becomes easier for the user to know which person is speaking, through expressing the character string of a male with blue since a male voice has a low sound frequency, and expressing the character string of a female with red since a female voice has a high sound frequency.

### Thirtieth Embodiment

FIG. 43 is a flowchart showing the order of the processing of the caption display control method in the reproducing apparatus (caption display control apparatus) according to a thirtieth embodiment of the present invention. This embodiment displays the captions in the optimum way in all the video scenes by means of the color and the display positions. When it is judged in step S20 that there is a remaining caption, the caption color changing processing m7 is performed. That is, in order to display the caption in the optimum way in all the scenes by using colors, first, the color of the caption is changed in accordance with the frequency of the sound in response to the reproducing time information of the video/audio data 2.

Then, the caption display position changing processing m8 is performed. That is, in order to make the display place optimum for all the video scenes, the caption is displayed by moving the display frame area to the position with a larger amplitude side in accordance with the magnitude of the sound amplitudes on the right and left sides, based on the sound information of the video/audio data 2. After performing the processing m8, it is shifted to step S30 of FIG. 2.

According to this embodiment, in expressing the conversation between a man and a woman as shown in FIG. 16, it is possible to express the character string of a male with blue since a male voice has a low sound frequency, and to express the character string of a female with red since a female voice has a high sound frequency, through changing the color in accordance with the frequency of the sound. Furthermore, through displaying the captions by moving the display frame area to the lager amplitude side in accordance with the magnitude of the sound amplitudes on the right and left sides, it is possible by simply looking at the captions to know which position (on the right or the left) the sound comes from. In addition, in a conversation, it is possible to judge in which direction the person's voice is larger and to obtain effect capable of grasping the current state by the color of the caption and the display position.

### Thirty-First Embodiment

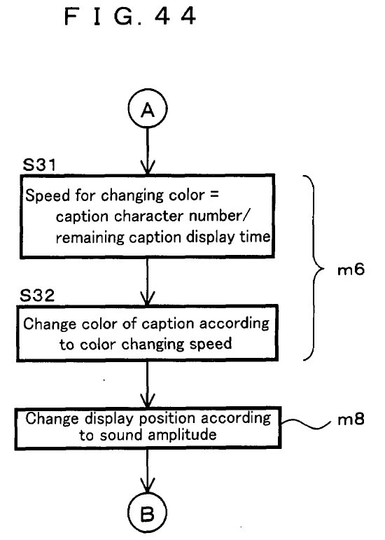

FIG. 44 is a flowchart showing the order of the processing of the caption display control method in the reproducing apparatus (caption display control apparatus) according to a thirty-first embodiment of the present invention. This embodiment displays the captions in the optimum way in all the video scenes by means of the color display and the display positions. When it is judged in step S20 that there is a remaining caption, the caption color scroll processing m6 is performed. That is, in step S31, the number of remaining caption characters is divided by the caption display period to obtain the speed for changing the color (color changing speed) in accordance with the reproducing time information of the video/audio data 2, in order to display the caption in the optimum way in all the scenes by using colors. Then, in step S32, the color of the caption is changed from the displayed forehand character at the obtained color changing speed.

Then, the caption display position changing processing m8 is performed. That is, in order to make the display place optimum for all the video scenes, the caption is displayed by moving the display frame area to the position with a larger amplitude side in accordance with the magnitude of the sound amplitudes on the right and left sides, based on the sound information of the video/audio data 2. After performing the processing m8, it is shifted to step S30 of FIG. 2.

This embodiment enables the user to obtain effect capable of grasping the current state by simply looking at the caption, through coloring the reproduced caption display part in gray or the like. In addition, through displaying the captions by moving the display frame area to the lager amplitude side in accordance with the magnitude of the sound amplitudes on the right and left sides, it is possible by simply looking at the captions to know which position (on the right or the left) the sound comes from. Furthermore, in a conversation, it is possible to judge in which direction the person's voice is larger and to obtain effect capable of grasping the current state by the color of the caption and the display position.

### Thirty-Second Embodiment

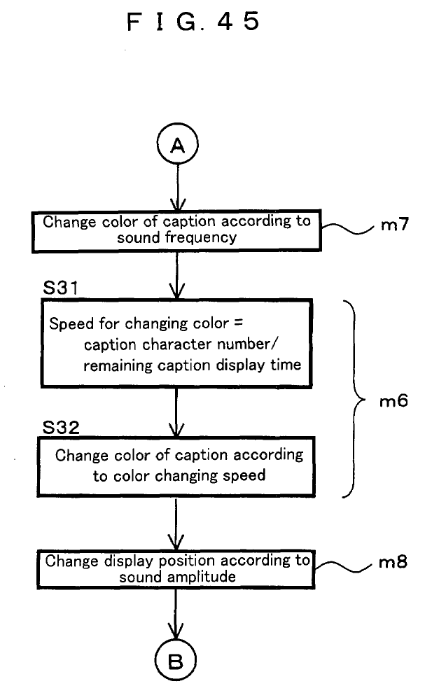

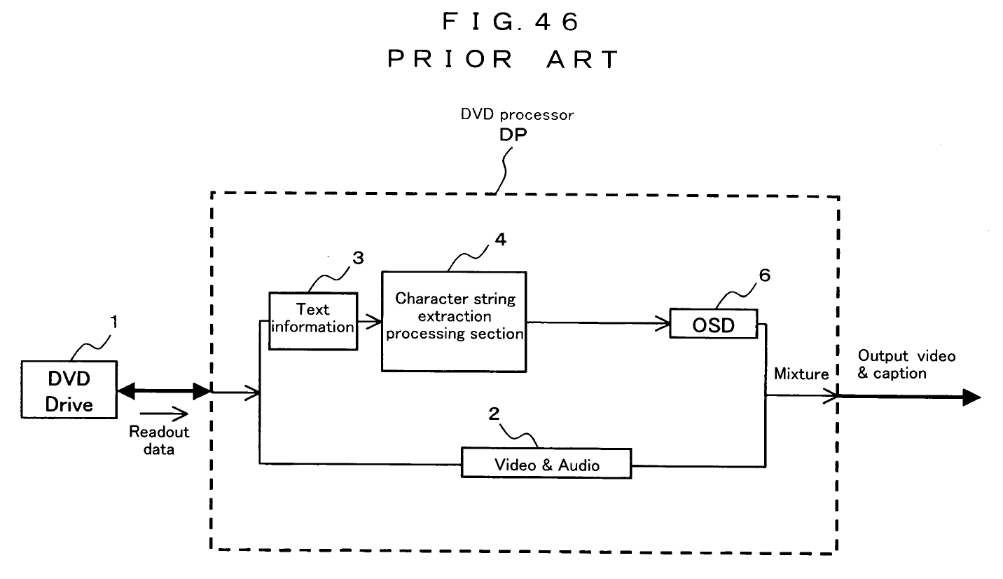

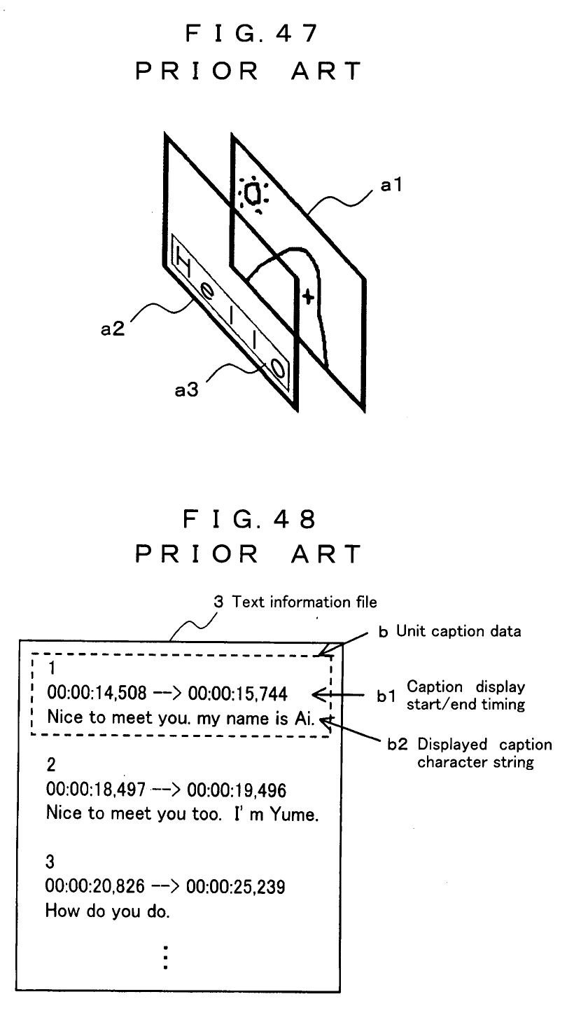

FIG. 45 is a flowchart showing the order of the processing of the caption display control method in the reproducing apparatus (capture display control apparatus) according to a thirty-second embodiment of the present invention. When it is judged in step S20 that there is a remaining caption, the caption color changing processing m7 is performed. That is, in order to display the caption in the optimum way in all the scenes by using colors, the color of the caption is changed in accordance with the frequency of the sound based on the sound information of the video/audio data 2.

Then, the caption color scroll processing m6 is performed. That is, in step S31, the number of remaining caption characters is divided by the caption display period to obtain the speed for changing the color (color changing speed) in accordance with the reproducing time of the video/audio data 2, in order to display the caption in the optimum way in all the scenes by using colors. Thereafter, in step S32, the color of the caption is changed from the displayed forehand character at the obtained color changing speed.

Then, the caption display position changing processing m8 is performed. That is, in order to make the display area optimum for all the video scenes, the caption is displayed by moving the display frame area to the position with a larger amplitude side in accordance with the magnitude of the sound amplitudes on the right and left sides, based on the sound information of the video/audio data 2. After performing the processing m8, it is shifted to step S30 of FIG. 2.

According to this embodiment, in expressing the conversation between a man and a woman, it is possible to express the character string of a male with blue since a male voice has a low sound frequency, and to express the character string of a female with red since a female voice has a high sound frequency, through changing the color in accordance with the frequency of the sound. Thus, it is easier for the user to know which person (the man or the woman) is speaking. In addition, this embodiment enables the user to obtain effect capable of grasping the current state easily by simply looking at the caption, through coloring the reproduced caption display part in gray or the like. Moreover, in order to grasp the current state more easily, the captions are displayed by moving the display frame area to the lager amplitude side in accordance with the magnitude of the sound amplitudes on the right and left sides. Therefore, it is possible by simply looking at the captions to know which direction (on the right or the left) the sound comes from and to judge in which direction the person's voice is larger in a conversation.

The present invention has been described in detail referring to the most preferred embodiments. However, various combinations and modifications of the components are possible without departing from the spirit and the broad scope of the appended claims.

1. A caption display control apparatus for reading out data from a recording medium in which main data including video data and text data are recorded in separate files respectively, and then displaying, as a caption, a character string generated from said text data in a prescribed display frame area within a video generated from said main data, said apparatus comprising:
a judging device for defining a reference character number indicating a number of characters that can be stored within said display frame area with an initially set character font size, and then judging whether or not a character number of said character string exceeds said reference character number; and
a display control device for displaying said character string with said character font size in said display frame area when said character number of said character string does not exceed said reference character number, and displaying said character string in a visually recognizable state in said display frame area or displaying said character string in said display frame area by fabricating so that it can be visually recognized that said character number of said character string exceeds said reference character number, when said character number of said character string exceeds said reference character number.

2. The caption display control apparatus according to claim 1, wherein, when said character number of said character string exceeds said reference character number, said display control device reduces said character font size of said character string.

3. The caption display control apparatus according to claim 1, wherein, when said character number of said character string exceeds said reference character number, said display control device scroll-displays said character string in said display frame area.

4. The caption display control apparatus according to claim 1, wherein, when said character number of said character string exceeds said reference character number, said display control device divides said character string by a paragraph unit, and displays each of partial character strings obtained by dividing said character string sequentially in chronological order.

5. The caption display control apparatus according to claim 1 wherein, when said character number of said character string exceeds said reference character number, said display control device divides said character string by a word unit into a displayable partial character string that can be displayed in said display frame area and a non-displayable partial character string, and displays said displayable partial character string in said display frame area.

6. The caption display control apparatus according to claim 1 wherein, when said character number of said character string exceeds said reference character number, said display control device divides said character string into a displayable partial character string that can be displayed in said display frame area and a non-displayable partial character string, and displays said displayable partial character string in said display frame area by adding a continuation mark to said displayable partial character string, indicating that there is a partial character string that cannot be displayed.

7. A caption display control apparatus for reading out data from a recording medium in which main data including video data and text data are recorded in separate files respectively, and displaying, as a caption, a character string generated from said text data in a prescribed display frame area within a video generated from said main data, said apparatus comprising:
a calculator for calculating a display speed that is a display time per character, through dividing said character number of said character string by a length of display time in said display frame area; and
a display control device for displaying a partial character string of said character string to be displayed in said display frame area with a color different from a color of other partial character strings, and shifting said partial character string in different color from a head of said character string to an end thereof at a moving speed that is same as said display speed.

8. A caption display control apparatus for reading out data from a recording medium in which main data including video data and audio data and text data are recorded in separate files respectively, and displaying, as a caption, a character string generated from said text data in a prescribed display frame area within a video generated from said main data, said apparatus comprising:
a measuring device for successively measuring an audio frequency of said audio data; and
a display control device for successively changing a display color of said character string to be displayed in said display frame area in accordance with said audio frequency measured by said measuring device.

9. A caption display control apparatus for reading out data from a recording medium in which main data including video data and audio data and text data are recorded in separate files respectively, and displaying, as a caption, a character string generated from said text data in a prescribed display frame area within a video generated from said main data, said apparatus comprising:
an amplitude checking device for checking an amplitude distribution of said audio data in said display frame area; and
a display control device for unevenly distributing said character string in a part of said display frame area with a larger amplitude.

10. A caption display control apparatus for reading out data from a recording medium in which main data including video data and audio data and text data are recorded in separate files respectively, and displaying, as a caption, a character string generated from said text data in a prescribed display frame area within a video generated from said main data, said apparatus comprising:
a comparator for comparing an aspect ratio of said video data and an aspect ratio of a video display monitor for displaying said video data; and
a display control device for moving said display frame area in a display screen of said video display monitor in accordance with a result of comparing said both aspect ratios.

11. The caption display control apparatus according to claim 10, wherein, when there is a difference between said both aspect ratios, said display control device moves said display frame area to a non-image part that is generated in said display screen of said video display monitor due to said difference between said aspect ratios.

12. The caption display control apparatus according to claim 10, further comprising a luminance checking device for checking luminance distribution of said video data, wherein
when said both aspect ratios are equal, said display control device moves said display frame area to a part of said display screen of said video display monitor with less luminance change.

13. The caption display control apparatus according to claim 10, wherein, when said both aspect ratios are equal, said display control device reduces displayed video and moves said display frame area to a non-image part that is generated by reducing said displayed video.
